(19) United States
(12) Patent Application Publication
(10) Pub. No.: US 2025/0193390 A1
(43) Pub. Date: Jun. 12, 2025

(54) ENCODING AND DECODING A PICTURE USING FILTERING BLOCKS

(71) Applicant: FRAUNHOFER-GESELLSCHAFT ZUR FOERDERUNG DER ANGEWANDTEN FORSCHUNG E.V., Muenchen (DE)

(72) Inventors: Valeri GEORGE, Berlin (DE); Adam WIECKOWSKI, Berlin (DE); Tobias HINZ, Berlin (DE); Jens BRANDENBURG, Berlin (DE); Benjamin BROSS, Berlin (DE); Yago SÁNCHEZ DE LA FUENTE, Berlin (DE); Robert SKUPIN, Berlin (DE); Thomas SCHIERL, Berlin (DE); Detlev MARPE, Berlin (DE); Thomas WIEGAND, Berlin (DE)

(21) Appl. No.: 19/059,547

(22) Filed: Feb. 21, 2025

Related U.S. Application Data
(63) Continuation of application No. PCT/EP2023/073064, filed on Aug. 22, 2023.

(30) Foreign Application Priority Data
Aug. 23, 2022 (EP) 22191810.5

(51) Int. Cl. H04N 19/117; H04N 19/119; H04N 19/124; H04N 19/176

(52) U.S. Cl. CPC H04N 19/117; H04N 19/119; H04N 19/124; H04N 19/176

(57) ABSTRACT

A picture of a sequence of pictures is decoded by deriving partitioning information from the data stream, subdividing the picture into coding blocks according to the partitioning information, and decoding the picture in units of the coding blocks. Filtering information is derived from the data stream, which indicates a subdivision of the picture into filtering blocks. The subdivision into filtering blocks is used for filtering the picture.

### CROSS-REFERENCE TO RELATED APPLICATIONS

This application is a continuation of copending International Application No. PCT/EP2023/073064, filed Aug. 22, 2023, which is incorporated herein by reference in its entirety, and additionally claims priority from European Application No. 22191810.5, filed Aug. 23, 2022, which is also incorporated herein by reference in its entirety.

### TECHNICAL FIELD

Embodiments of the present invention are concerned with video coding/decoding. Some embodiments are related to an apparatus for determining of filter parameters for frame sub-areas.

### BACKGROUND OF THE INVENTION

Since H.261, all video coding standards, including the state-of-the-art ITU T H.266|MPEG-I Part 3 VVC video coding standard (reference 1: ITU-T and ISO/IEC. Versatile video coding. ITU-T Recommendation H.266| ISO/IEC 23090-3 (VVC), edition 2, 2022), rely on the basic concept of block-based hybrid video coding. Here the input signal for each color component is segmented into disjoint blocks, which are encoded using a hybrid video coding scheme, based on prediction, transform, quantization, (in-loop) filtering and entropy coding. Thus, one of the steps in the encoding and decoding algorithm is the filtering or de-noising of quantized signal for the current block. Embodiments of this invention described below focus on the Adaptive Loop Filter (ALF) and improving of methods for the derivation of its parameters. However, the method can be applied to any in-loop filter that has parameters to be signaled on a per-block level, e.g. Sample Adaptive Offset (SAO) or future neural network-based filters.

In the current video coding standards, the basic approach is to divide the input samples into basic processing units, so called Coding Tree Units (CTU), illustrated with solid lines in FIG. 1. While these units are further partitioned with respect to the coding process, filter parameters are determined for each basic processing unit (CTU) respectively. Therefore, the filter processing blocks, i.e. the blocks to which a filter can be applied with the same parameters, placed on the same grid as the CTUs. The obtained parameters are then coded, for example, via entropy coding and transmitted to the decoder side. In the following, this kind of filtering blocks are named Filter Processing Units (FPU), shown as white boxes separated with the dashed lines in FIG. 1 below.

On the encoder side, the coded and decoded/reconstructed picture is the input to the filtering processes. In VVC, this includes Luma Mapping with Chroma Scaling (LMCS), Deblocking, SAO and ALF, in that order. Future video codecs might employ even more or different in-loop filtering stages. Due to lossy compression introduced by quantization, the original picture loses on visual quality. Various coding artifacts are typical kind of distortion found in the reconstructed picture. Especially in ALF, a key feature is the Wiener Filter that allows restoring a lot of the losses by bringing the filtered picture closer to the uncompressed original. Such a filter typically processes each sample of the distorted picture. To know how to process the sample, filter requires a set of parameters: in case of ALF filter coefficients, for SAO the type of filtering and associated offset values, in case of LMCS activation flag plus mapping values. Deblocking does not require per-block parameters but its filtering strength is also controlled by thresholds derived from the quantization parameter (QP), which can change on a block level as well.

Ideally, for one picture sample one set of parameters needed. This would result in a huge amount of signaling data drastically increasing the size of the bitstream. To reduce the parameter signaling overhead, one parameter set is used for a block of samples, e.g., referred to as FPU. In VVC standard, such a block equals to the size of the basic processing unit, i.e. the CTU. For ALF, typically, there is a predefined set of different filters, each with specific coefficients and correspondent filtering characteristics that can be signaled. Then, the encoder just need to transmit the index of the chosen filter for each block.

Especially for ALF, the following algorithm may be used. Besides the already predefined set of filters, new filters that probably better suit to enhance the current picture content can be designed during the encoding process. Typically, to limit the encoder complexity, one set of filter coefficients is determined for each new picture. This includes sample-wise classification of picture content, gathering correlation statistics between the reconstructed and original picture, FPU-wise accumulation of these and finally solving a system of linear equations. As a result, the determined filter coefficients satisfy a minimum distortion criterion for all FPUs in the picture. In a last step, the best filtering mode is determined for each FPU with respect to an encoder specific optimization criterion, i.e. filter-off or filter on using the filter from all currently available filters that is optimal for the chosen criterion.

In VVC for ALF, the FPU corresponds to the CTU and there are three parameters signaled on CTU level: alf_ctb_flag, alf_luma_filter_idx, alf_ctb_filter_alternative_idx. If a newly determined filter is used for some FPUs, its parameters (coefficients, etc.) are transmitted to the decoder using the Adaptation Parameter Set (APS), which increases the list of the available filters. The new filter will be also available for the upcoming pictures.

The above-described features may optionally be implemented in any of the embodiments described below individually or in combination.

There is an ongoing desire to provide a video coding concept, in particular an encoder, a decoder, methods for encoding and decoding, and a video data stream, which provides an improved trade-off between a rate-distortion relation of the encoded video signal, complexity, and requirements on resources such as computational or memory resources.

### SUMMARY

An embodiment may have an apparatus for decoding a picture of a sequence of pictures from a data stream, the apparatus being configured for subdividing the picture into the coding blocks by partitioning the picture into tree root blocks, and subdividing the tree root blocks using recursive tree splitting, and decoding the picture in units of the coding blocks, wherein the apparatus is configured for filtering the picture using a filter by using, for each of filtering blocks, into which the picture is subdivided, a respective parametrization for the filter, wherein the subdivision of the picture into the filtering blocks is different from the subdivision of the picture into the tree root blocks.

Another embodiment may have an apparatus for encoding a picture of a sequence of pictures into a data stream, the apparatus being configured for subdividing the picture into coding blocks by partitioning the picture into tree root blocks, and subdividing the tree root blocks using recursive tree splitting, and encoding the picture in units of the coding blocks, wherein the apparatus is configured for using a prediction signal for predicting the picture to obtain a residual signal, subjecting the residual signal to a spatial-to-spectral transform to obtain a transform signal, quantizing the transform signal to obtain a quantized signal, and encoding the quantized signal into the data stream, and deriving the prediction signal for predicting a subsequent picture of the sequence of pictures by reconstructing the picture based on the quantized signal to obtain a reconstructed picture, wherein the apparatus is configured for filtering the reconstructed picture using a filter by using, for each of the filtering blocks, into which the reconstructed picture is subdivided according to the subdivision of the picture into filtering blocks, the respective parametrization for the filter.

According to another embodiment, a method for decoding a picture of a sequence of pictures from a data stream may have the steps of: subdividing the picture into the coding blocks by partitioning the picture into tree root blocks, and subdividing the tree root blocks using recursive tree splitting, and decoding the picture in units of the coding blocks, and filtering the picture using a filter by using, for each of filtering blocks, into which the picture is subdivided, a respective parametrization for the filter, wherein the subdivision of the picture into the filtering blocks is different from the subdivision of the picture into the tree root blocks.

According to another embodiment, a method for encoding a picture of a sequence of pictures into a data stream may have the steps of: subdividing the picture into the coding blocks by partitioning the picture into tree root blocks, and subdividing the tree root blocks using recursive tree splitting, and encoding the picture in units of the coding blocks, wherein the method has: using a prediction signal for predicting the picture to obtain a residual signal, subjecting the residual signal to a spatial-to-spectral transform to obtain a transform signal, quantizing the transform signal to obtain a quantized signal, and encoding the quantized signal into the data stream, and deriving the prediction signal for predicting a subsequent picture of the sequence of pictures by reconstructing the picture based on the quantized signal to obtain a reconstructed picture, and filtering the reconstructed picture using a filter by using, for each of the filtering blocks, into which the reconstructed picture is subdivided according to the subdivision of the picture into filtering blocks, the respective parametrization for the filter.

Another embodiment may have a video data stream having a sequence of pictures, the sequence of pictures being encoded into the data stream using the above method of claim for encoding.

Embodiments of the present invention rely on the idea that a filtering of the picture, e.g. the reconstructed picture, may reduce coding artifacts particularly efficient, if the filter is adapted to a content of the picture in units of filtering blocks, and that it may be advantageous in this respect to facilitate a subdivision of the picture into the filtering blocks which is flexible and/or which deviates from a subdivision of the picture into coding block, in units of which the picture is coded, e.g. in terms of prediction. In particular, the inventors found, that an increased complexity and/or signaling overhead, which may be the result from allowing a flexible subdivision into filtering blocks and/or a subdivision which deviates from the subdivision into coding blocks, may be overcompensated by an increased efficiency in reducing coding artifact. An efficient filtering may result in a better rate-distortion relation, or in an equivalent rate-distortion relation at lower complexity and/or decreased resource requirements.

Embodiments of the invention provide an apparatus for decoding a picture of a sequence of pictures from a data stream, the apparatus being configured for deriving partitioning information from the data stream, subdividing the picture into coding blocks according to the partitioning information, and decoding the picture in units of the coding blocks. The apparatus is configured for filtering the picture by deriving, from the data stream (e.g. in addition to the partitioning information), filtering information (e.g., size or splitting information) which indicates a subdivision of the picture into filtering blocks, and using the subdivision of the picture into filtering blocks for filtering the picture (e.g. filtering the picture with a granularity of the subdivision, e.g. subjecting the picture to a filter in units of the filtering blocks).

The usage of filtering information, which is signaled in the data stream, allows a flexible subdivision of the picture into the filtering blocks for the filtering. In particular, as the filtering information is signaled in addition to the partitioning information, the subdivision into filtering blocks may be independent from the subdivision into coding blocks. Therefore, the signaling of the filtering information allows a flexible adaption of the filtering, e.g., in terms of a filtering function, in units of the filtering blocks, and, as the filtering blocks may be determined flexibly, an adaption to the picture. For example, for homogeneous content, a larger grid as illustrated may be beneficial, since the filter parameters are expected to be homogenous as well, and a larger grid may cause less signaling overhead for signaling the subdivision into filtering blocks (and in examples, for signaling parameters for the filtering). For more structured content with a lot of activity, that is rich on high spatial frequencies, smaller filtering blocks may be beneficial by exploiting the diversity of different filters in a picture. In this case, the additional signaling overhead may be overcompensated so that an overall rate-distortion measure may be improved.

Further embodiments of the invention provide an apparatus for encoding a picture of a sequence of pictures into a data stream, the apparatus being configured for subdividing the picture into coding blocks, encoding the picture in units of the coding blocks, and encoding partitioning information into the data stream, the partitioning information indicating the subdivision of the picture into the coding blocks. The apparatus is configured for deriving a subdivision of the picture into filtering blocks, and for each of the filtering blocks, a respective parametrization for a filter for filtering the filtering block, and encoding, into the data stream, filtering information, which indicates the subdivision of the picture into the filtering blocks.

Further embodiments provide a method for decoding a picture of a sequence of pictures from a data stream, the method comprising: deriving partitioning information from the data stream, subdividing the picture into coding blocks according to the partitioning information, and decoding the picture in units of the coding blocks, and filtering the picture, the filtering being performed by deriving, from the data stream (e.g. in addition to the partitioning information), filtering information which indicates a subdivision of the picture into filtering blocks, and using the subdivision of the picture into filtering blocks for filtering the picture (e.g. filtering the picture with a granularity of the subdivision, e.g. subjecting the picture to a filter in units of the filtering blocks).

Further embodiments provide a method for encoding a picture of a sequence of pictures into a data stream, the method comprising: subdividing the picture into coding blocks, encoding the picture in units of the coding blocks, and encoding partitioning information into the data stream, the partitioning information indicating the subdivision of the picture into the coding blocks; deriving a subdivision of the picture into filtering blocks, and for each of the filtering blocks, a respective parametrization for a filter for filtering the filtering block; and encoding, into the data stream, filtering information, which indicates the subdivision of the picture into the filtering blocks.

Further embodiments provide an apparatus for decoding a picture of a sequence of pictures from a data stream, the apparatus being configured for subdividing the picture into coding blocks (e.g., in units of which prediction may be performed) by partitioning the picture into tree root blocks (e.g., quadratic blocks, equally sized blocks, regularly in rows and columns, e.g., CTUs), and subdividing the tree root blocks using recursive tree splitting (e.g., each of the parent block forms a root for a splitting tree, e.g., the apparatus splits the tree root block into child blocks, each of the child blocks being input to a subsequent recursion of the recursive tree splitting to split the child blocks into child blocks of the child block, e.g., until a child block fulfils a predetermined criterion.), and decoding the picture in units of the coding blocks. The apparatus is configured for filtering the picture using a filter by using, for each of filtering blocks, into which the picture is subdivided, a respective parametrization for the filter, wherein the subdivision of the picture into the filtering blocks is different from the subdivision of the picture into the tree root blocks.

The inventors found that a subdivision of the picture, which is different from the subdivision into tree root blocks, may provide a more efficient filtering in terms of a reduction of coding artifacts. In particular, the additional effort of deriving the subdivision into filtering blocks may be overcompensated by the enhanced filtering, so that the overall tradeoff between rate-distortion relation, complexity and resource requirements may be improved by using a subdivision into filtering blocks different from the tree root blocks.

Further embodiments provide an apparatus for encoding a picture of a sequence of pictures into a data stream, the apparatus being configured for subdividing the picture into coding blocks by partitioning the picture into tree root blocks (e.g., quadratic blocks, equally sized blocks, regularly in rows and columns, e.g., CTUs), and subdividing the tree root blocks using recursive tree splitting (e.g., each of the parent block forms a root for a splitting tree, e.g., the apparatus splits the tree root block into child blocks, each of the child blocks being input to a subsequent recursion of the recursive tree splitting to split the child blocks into child blocks of the child block, e.g., until a child block fulfils a predetermined criterion.), and encoding the picture in units of the coding blocks. The apparatus is configured for using a prediction signal for predicting the picture to obtain a residual signal; subjecting the residual signal to a spatial-to-spectral transform to obtain a transform signal; quantizing the transform signal to obtain a quantized signal, and encoding the quantized signal into the data stream; and deriving the prediction signal for predicting a subsequent picture of the sequence of pictures by reconstructing the picture based on the quantized signal to obtain a reconstructed picture. The apparatus is configured for filtering the reconstructed picture using a filter by using, for each of the filtering blocks, into which the reconstructed picture is subdivided according to the subdivision of the picture into filtering blocks, the respective parametrization for the filter.

Further embodiments provide a method for decoding a picture of a sequence of pictures from a data stream, the method comprising: subdividing the picture into the coding blocks by partitioning the picture into tree root blocks, and subdividing the tree root blocks using recursive tree splitting, and decoding the picture in units of the coding blocks; and filtering the picture using a filter by using, for each of filtering blocks, into which the picture is subdivided, a respective parametrization for the filter, wherein the subdivision of the picture into the filtering blocks is different from the subdivision of the picture into the tree root blocks.

Further embodiments provide a method for encoding a picture of a sequence of pictures into a data stream, the method comprising: subdividing the picture into the coding blocks by partitioning the picture into tree root blocks, and subdividing the tree root blocks using recursive tree splitting, and encoding the picture in units of the coding blocks. The method comprises: using a prediction signal for predicting the picture to obtain a residual signal; subjecting the residual signal to a spatial-to-spectral transform to obtain a transform signal; quantizing the transform signal to obtain a quantized signal, and encoding the quantized signal into the data stream, and deriving the prediction signal for predicting a subsequent picture of the sequence of pictures by reconstructing the picture based on the quantized signal to obtain a reconstructed picture; and filtering the reconstructed picture using a filter by using, for each of the filtering blocks, into which the reconstructed picture is subdivided according to the subdivision of the picture into filtering blocks, the respective parametrization for the filter.

Further embodiments provide a video data stream a sequence of pictures, the sequence of pictures being encoded into the data stream using any of the methods for encoding a picture.

### BRIEF DESCRIPTION OF THE DRAWINGS

Embodiments of the present disclosure are described in more detail below with respect to the figures, among which:

FIG. 1 illustrates an example of filter processing units;

FIG. 2 illustrates an example of an encoder;

FIG. 3 illustrates an example of a decoder;

FIG. 4 illustrates an example of a subdivision of a picture;

FIG. 5 illustrates a decoder according to an embodiment;

FIG. 6 illustrates an encoder according to an embodiment;

FIG. 7 illustrates filtering blocks in relation to a subdivision into slices according to an embodiment;

FIG. 8 illustrates filtering blocks in relation to a subdivision into portions according to an embodiment;

FIG. 9 illustrates a decoder according to a further embodiment;

FIG. 10 illustrates an encoder according to a further embodiment;

FIG. 11 illustrates a picture subdivided into filtering blocks comprising multiple coding blocks according to an embodiment; and

FIG. 12 illustrates a picture subdivided into coding blocks comprising multiple filtering blocks according to an embodiment.

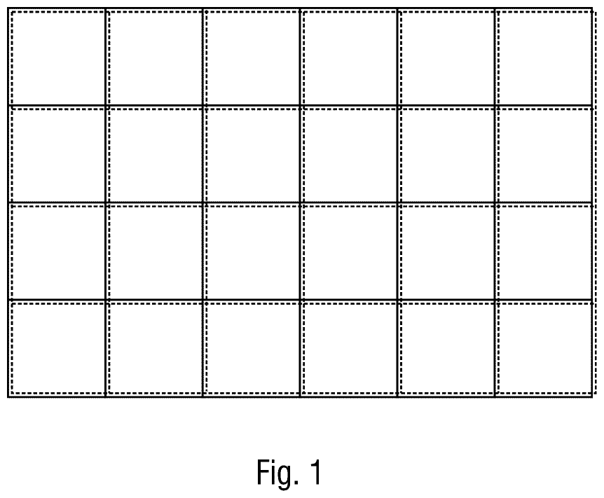

### DETAILED DESCRIPTION OF THE INVENTION

Embodiments of the present invention are now described in more detail with reference to the accompanying drawings, in which the same or similar elements or elements that have the same or similar functionality have the same reference signs assigned or are identified with the same name. In the following description, a plurality of details is set forth to provide a thorough explanation of embodiments of the disclosure. However, it will be apparent to one skilled in the art that other embodiments may be implemented without these specific details. In addition, features of the different embodiments described herein may be combined with each other, unless specifically noted otherwise.

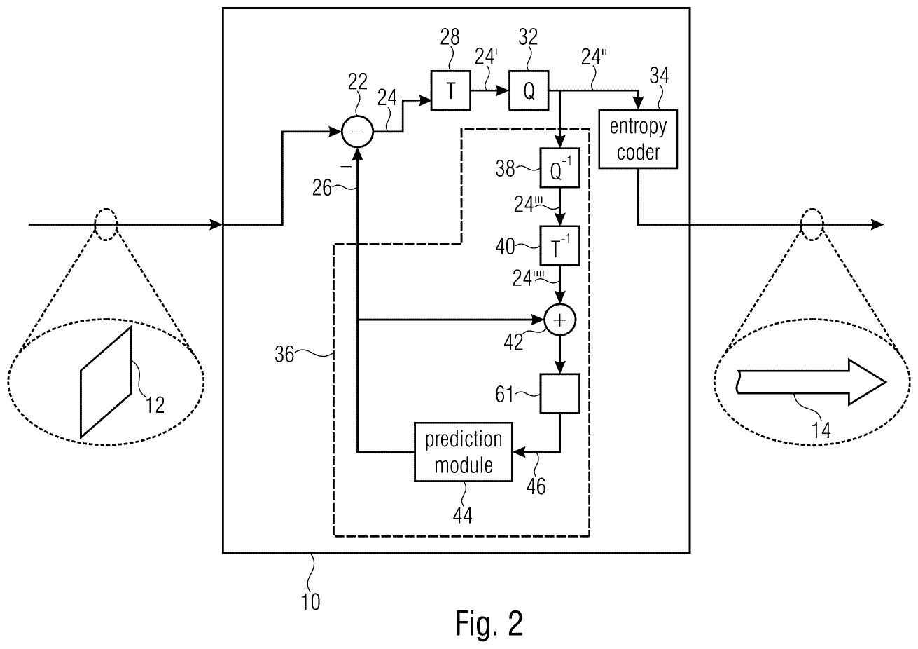

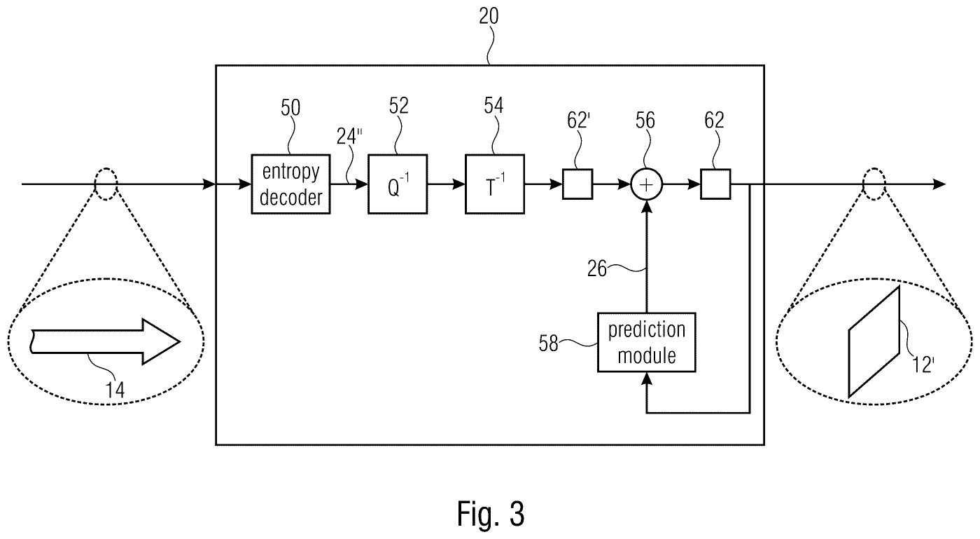

The following description starts with a description of an encoder and a decoder of a block-based predictive codec for coding pictures of a video in order to form an example for a coding framework into which embodiments of the present invention may be built in. The respective encoder and decoder are described with respect to FIGS. 2, 3, and 4. Thereinafter the description of embodiments of the concept of the present invention is presented along with a description as to how such concepts could be built into the encoder and decoder of FIGS. 2, and 3, respectively, although the embodiments described with the subsequent Figures and following, may also be used to form encoders and decoders not operating according to the coding framework underlying the encoder and decoder of FIGS. 2, and 3.

FIG. 2 shows an apparatus for predictively coding a picture 12 into a data stream 14 exemplarily using transform-based residual coding. The apparatus, or encoder, is indicated using reference sign 10. FIG. 3 shows a corresponding decoder 20, i.e. an apparatus 20 configured to predictively decode the picture 12′ from the data stream 14 also using transform-based residual decoding, wherein the apostrophe has been used to indicate that the picture 12′ as reconstructed by the decoder 20 deviates from picture 12 originally encoded by apparatus 10 in terms of coding loss introduced by a quantization of the prediction residual signal. FIG. 2 and FIG. 3 exemplarily use transform based prediction residual coding, although embodiments of the present application are not restricted to this kind of prediction residual coding. This is true for other details described with respect to FIGS. 2, and 3, too, as will be outlined hereinafter.

The encoder 10 is configured to subject the prediction residual signal to spatial-to-spectral transformation and to encode the prediction residual signal, thus obtained, into the data stream 14. Likewise, the decoder 20 is configured to decode the prediction residual signal from the data stream 14 and subject the prediction residual signal thus obtained to spectral-to-spatial transformation.

Internally, the encoder 10 may comprise a prediction residual signal former 22 which generates a prediction residual 24 so as to measure a deviation of a prediction signal 26 from the original signal, i.e. from the picture 12. The prediction residual signal former 22 may, for instance, be a subtractor which subtracts the prediction signal from the original signal, i.e. from the picture 12. The encoder 10 then further comprises a transformer 28 which subjects the prediction residual signal 24 to a spatial-to-spectral transformation to obtain a spectral-domain prediction residual signal 24′ which is then subject to quantization by a quantizer 32, also comprised by the encoder 10. The thus quantized prediction residual signal 24″ is coded into bitstream 14. To this end, encoder 10 may optionally comprise an entropy coder 34 which entropy codes the prediction residual signal as transformed and quantized into data stream 14. The prediction signal 26 is generated by a prediction stage 36 of encoder 10 on the basis of the prediction residual signal 24″ encoded into, and decodable from, data stream 14. To this end, the prediction stage 36 may internally, as is shown in FIG. 2, comprise a dequantizer 38 which dequantizes prediction residual signal 24″ so as to gain spectral-domain prediction residual signal 24″′, which corresponds to signal 24′ except for quantization loss, followed by an inverse transformer 40 which subjects the latter prediction residual signal 24″′ to an inverse transformation, i.e. a spectral-to-spatial transformation, to obtain prediction residual signal 24″″, which corresponds to the original prediction residual signal 24 except for quantization loss. A combiner 42 of the prediction stage 36 then recombines, such as by addition, the prediction signal 26 and the prediction residual signal 24″″ so as to obtain a reconstructed signal 46, i.e. a reconstruction of the original signal 12. Reconstructed signal 46 may correspond to signal 12′. A prediction module 44 of prediction stage 36 then generates the prediction signal 26 on the basis of signal 46 by using, for instance, spatial prediction, i.e. intra-picture prediction, and/or temporal prediction, i.e. inter-picture prediction.

Likewise, decoder 20, as shown in FIG. 3, may be internally composed of components corresponding to, and interconnected in a manner corresponding to, prediction stage 36. In particular, entropy decoder 50 of decoder 20 may entropy decode the quantized spectral-domain prediction residual signal 24″ from the data stream, whereupon dequantizer 52, inverse transformer 54, combiner 56 and prediction module 58, interconnected and cooperating in the manner described above with respect to the modules of prediction stage 36, recover the reconstructed signal on the basis of prediction residual signal 24″ so that, as shown in FIG. 3, the output of combiner 56 results in the reconstructed signal, namely picture 12′.

Although not specifically described above, it is readily clear that the encoder 10 may set some coding parameters including, for instance, prediction modes, motion parameters and the like, according to some optimization scheme such as, for instance, in a manner optimizing some rate and distortion related criterion, i.e. coding cost. For example, encoder 10 and decoder 20 and the corresponding modules 44, 58, respectively, may support different prediction modes such as intra-coding modes and inter-coding modes. The granularity at which encoder and decoder switch between these prediction mode types may correspond to a subdivision of picture 12 and 12′, respectively, into coding segments or coding blocks. In units of these coding segments, for instance, the picture may be subdivided into blocks being intra-coded and blocks being inter-coded. Intra-coded blocks are predicted on the basis of a spatial, already coded/decoded neighborhood of the respective block as is outlined in more detail below. Several intra-coding modes may exist and be selected for a respective intra-coded segment including directional or angular intra-coding modes according to which the respective segment is filled by extrapolating the sample values of the neighborhood along a certain direction which is specific for the respective directional intra-coding mode, into the respective intra-coded segment. The intra-coding modes may, for instance, also comprise one or more further modes such as a DC coding mode, according to which the prediction for the respective intra-coded block assigns a DC value to all samples within the respective intra-coded segment, and/or a planar intra-coding mode according to which the prediction of the respective block is approximated or determined to be a spatial distribution of sample values described by a two-dimensional linear function over the sample positions of the respective intra-coded block with driving tilt and offset of the plane defined by the two-dimensional linear function on the basis of the neighboring samples. Compared thereto, inter-coded blocks may be predicted, for instance, temporally. For inter-coded blocks, motion vectors may be signaled within the data stream, the motion vectors indicating the spatial displacement of the portion of a previously coded picture of the video to which picture 12 belongs, at which the previously coded/decoded picture is sampled in order to obtain the prediction signal for the respective inter-coded block. This means, in addition to the residual signal coding comprised by data stream 14, such as the entropy-coded transform coefficient levels representing the quantized spectral-domain prediction residual signal 24″, data stream 14 may have encoded thereinto coding mode parameters for assigning the coding modes to the various blocks, prediction parameters for some of the blocks, such as motion parameters for inter-coded segments, and optional further parameters such as parameters for controlling and signaling the subdivision of picture 12 and 12′, respectively, into the segments. The decoder 20 uses these parameters to subdivide the picture in the same manner as the encoder did, to assign the same prediction modes to the segments, and to perform the same prediction to result in the same prediction signal.

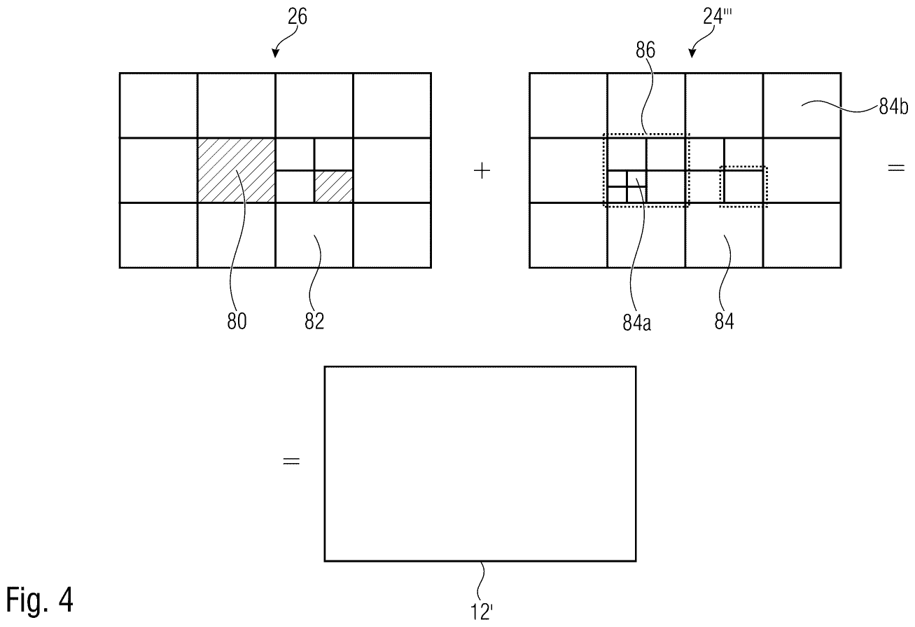

FIG. 4 illustrates the relationship between the reconstructed signal, i.e. the reconstructed picture 12′, on the one hand, and the combination of the prediction residual signal 24″″ as signaled in the data stream 14, and the prediction signal 26, on the other hand. As already denoted above, the combination may be an addition. The prediction signal 26 is illustrated in FIG. 4 as a subdivision of the picture area into intra-coded blocks which are illustratively indicated using hatching, and inter-coded blocks which are illustratively indicated not-hatched. The subdivision may be any subdivision, such as a regular subdivision of the picture area into rows and columns of square blocks or non-square blocks, or a multi-tree subdivision of picture 12 from a tree root block into a plurality of leaf blocks of varying size, such as a quadtree subdivision or the like, wherein a mixture thereof is illustrated in FIG. 4 in which the picture area is first subdivided into rows and columns of tree root blocks which are then further subdivided in accordance with a recursive multi-tree subdivisioning into one or more leaf blocks.

Again, data stream 14 may have an intra-coding mode coded thereinto for intra-coded blocks 80, which assigns one of several supported intra-coding modes to the respective intra-coded block 80. For inter-coded blocks 82, the data stream 14 may have one or more motion parameters coded thereinto. Generally speaking, inter-coded blocks 82 are not restricted to being temporally coded. Alternatively, inter-coded blocks 82 may be any block predicted from previously coded portions beyond the current picture 12 itself, such as previously coded pictures of a video to which picture 12 belongs, or picture of another view or an hierarchically lower layer in the case of encoder and decoder being scalable encoders and decoders, respectively.

The prediction residual signal 24″″ in FIG. 4 is also illustrated as a subdivision of the picture area into blocks 84. These blocks might be called transform blocks in order to distinguish same from the coding blocks 80 and 82. In effect, FIG. 4 illustrates that encoder 10 and decoder 20 may use two different subdivisions of picture 12 and picture 12′, respectively, into blocks, namely one subdivisioning into coding blocks 80 and 82, respectively, and another subdivision into transform blocks 84. Both subdivisions might be the same, i.e. each coding block 80 and 82, may concurrently form a transform block 84, but FIG. 4 illustrates the case where, for instance, a subdivision into transform blocks 84 forms an extension of the subdivision into coding blocks 80, 82 so that any border between two blocks of blocks 80 and 82 overlays a border between two blocks 84, or alternatively speaking each block 80, 82 either coincides with one of the transform blocks 84 or coincides with a cluster of transform blocks 84. However, the subdivisions may also be determined or selected independent from each other so that transform blocks 84 could alternatively cross block borders between blocks 80, 82. As far as the subdivision into transform blocks 84 is concerned, similar statements are thus true as those brought forward with respect to the subdivision into blocks 80, 82, i.e. the blocks 84 may be the result of a regular subdivision of picture area into blocks (with or without arrangement into rows and columns), the result of a recursive multi-tree subdivisioning of the picture area, or a combination thereof or any other sort of blockation. Just as an aside, it is noted that blocks 80, 82 and 84 are not restricted to being of quadratic, rectangular or any other shape.

FIG. 4 further illustrates that the combination of the prediction signal 26 and the prediction residual signal 24″″ directly results in the reconstructed signal 12′. However, it should be noted that more than one prediction signal 26 may be combined with the prediction residual signal 24″″ to result into picture 12′ in accordance with alternative embodiments.

In FIG. 4, the transform blocks 84 shall have the following significance. Transformer 28 and inverse transformer 54 perform their transformations in units of these transform blocks 84. For instance, many codecs use some sort of DST or DCT for all transform blocks 84. Some codecs allow for skipping the transformation so that, for some of the transform blocks 84, the prediction residual signal is coded in the spatial domain directly. However, in accordance with embodiments described below, encoder 10 and decoder 20 are configured in such a manner that they support several transforms. For example, the transforms supported by encoder 10 and decoder 20 could comprise:
DCT-II (or DCT-III), where DCT stands for Discrete Cosine Transform
DST-IV, where DST stands for Discrete Sine Transform
DCT-IV
DST-VII
Identity Transformation (IT)

Naturally, while transformer 28 would support all of the forward transform versions of these transforms, the decoder 20 or inverse transformer 54 would support the corresponding backward or inverse versions thereof:
Inverse DCT-II (or inverse DCT-III)
Inverse DST-IV
Inverse DCT-IV
Inverse DST-VII
Identity Transformation (IT)

The subsequent description provides more details on which transforms could be supported by encoder 10 and decoder 20. In any case, it should be noted that the set of supported transforms may comprise merely one transform such as one spectral-to-spatial or spatial-to-spectral transform.

As already outlined above, FIGS. 2, 3 and 4 have been presented as an example where the inventive concept described further below may be implemented in order to form specific examples for encoders and decoders according to the present application. Insofar, the encoder and decoder of FIGS. 2, and 3, respectively, may represent possible implementations of the encoders and decoders described herein below. FIGS. 2, and 3 are, however, only examples. An encoder according to embodiments of the present application may, however, perform block-based encoding of a picture 12 using the concept outlined in more detail below and being different from the encoder of FIG. 2 such as, for instance, in that same is no video encoder, but a still picture encoder, in that same does not support inter-prediction, or in that the sub-division into blocks 80 is performed in a manner different than exemplified in FIG. 4. Likewise, decoders according to embodiments of the present application may perform block-based decoding of picture 12′ from data stream 14 using the coding concept further outlined below, but may differ, for instance, from the decoder 20 of FIG. 3 in that same is no video decoder, but a still picture decoder, in that same does not support intra-prediction, or in that same sub-divides picture 12′ into blocks in a manner different than described with respect to FIG. 4 and/or in that same does not derive the prediction residual from the data stream 14 in transform domain, but in spatial domain, for instance.

As illustrated in FIG. 3, decoder 20 may further comprise a filtering module 62, which filters the reconstructed signal 12′, the prediction 58 being performed based on the filtered reconstructed signal 12′. Alternatively or additionally, filtering may be performed prior to the combination 56, i.e. the inversely quantized and retransformed signal may be subjected to the filtering prior to combination 56 with the prediction signal, as illustrated by filtering module 62′ in FIG. 3. The filtering by filtering module 62, 62′ is referred to as in-loop filtering. Similarly, encoder 10 of FIG. 2 may comprise a filtering module 61, which may perform the same filtering as filtering module 62, in the prediction stage 36 to filter the reconstructed signal 46. Additionally or alternatively, the prediction residual signal 24″″ may be subjected to filtering prior to combiner 42, as mentioned with respect to the decoder 20. Accordingly, embodiments of the invention may optionally be implemented as described with respect to FIGS. 2, 3, and 4, the filtering referring to filtering modules 61, 62 and/or 62′.

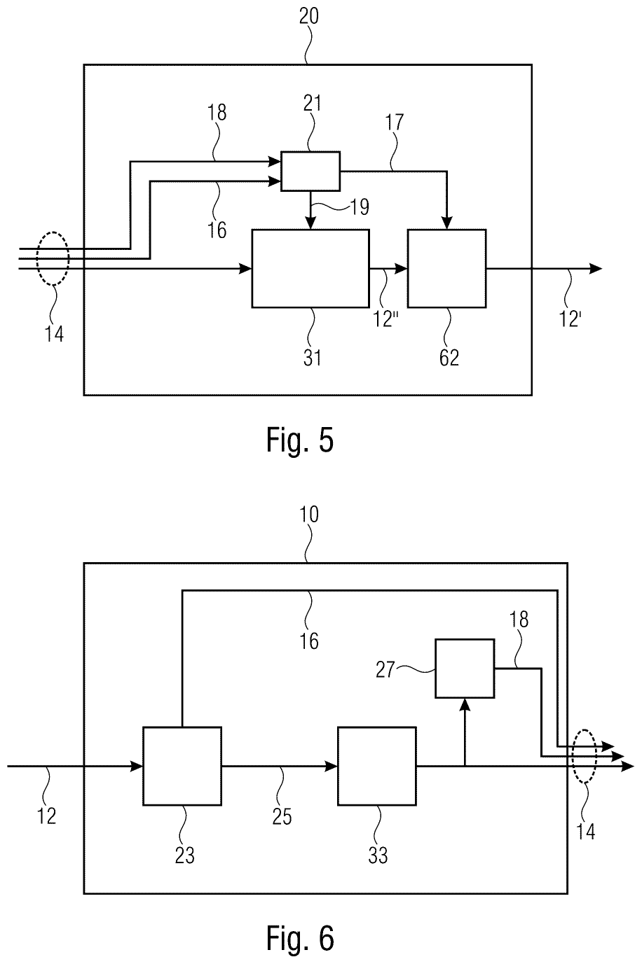

FIG. 5 illustrates an apparatus 20 for decoding or reconstructing a picture 12′ from a data stream 14 according to an embodiment. Apparatus 20 is also referred to as decoder 20. Details described with respect to FIG. 3 may optionally, but not necessarily, be implemented in decoder 20 of FIG. 5. Picture 12′ may be part of a sequence of pictures, which may be decoded according to a coding order among the pictures. Decoder 20 derives partitioning information 16 from the data stream 14 and subdivides, e.g. by means of subdivider 21 illustrated in FIG. 5, the picture 12′, which is to be reconstructed, into coding blocks according to the partitioning information. That is, e.g., subdivider 21 may derive a subdivision 19 for picture 12′ into coding blocks. Decoder 12 decodes, e.g. by means of decoding block 31 shown in FIG. 5, the picture 12′ in units of the coding blocks. In examples, decoder 20 may decode the coding blocks according to a coding order among the coding blocks of picture 12′. Decoder 20 further filters the picture, which is to be reconstructed. To this end, decoder 20 derives filtering information 18 from the data stream 14, e.g., size of splitting information, which indicates a subdivision of the picture into filtering blocks. Decoder 20 uses the subdivision of the picture into filtering blocks for filtering the picture. That is, e.g., decoder 20 may derive a further subdivision 17 of picture 12′ into filtering blocks based on the filtering information.

For example, the subdivision 17 into filtering blocks may be obtained by subdivider 21, or by separate means, e.g., decoder 20 may comprise a block for determining the subdivision into coding blocks and a block for determining the subdivision into filtering blocks, which blocks may be combined or separate from each other.

For example, decoder 20 may subject a decoded picture signal 12″ provided by decoding block 31 to the filtering, e.g. as illustrated by filtering block 62 in FIG. 5. It is noted, however, that the arrangement of filtering block 62 in FIG. 5 is exemplarily. In other examples, filtering block 62 may be part of the decoding block 31, e.g. as described with respect to filtering module 61 of FIG. 3.

For example, decoding block 31 may comprise blocks 52, 54, 56, and 58 of FIG. 3.

FIG. 6 illustrates an apparatus 10 for encoding a picture 12 into a data stream 14 according to an embodiment. Apparatus 10 is also referred to as encoder 10. Features described with respect to FIG. 2 may optionally but not necessarily be implemented in encoder 10 of FIG. 6. Encoder 10 may of FIG. 6 may be implemented as counterpart of decoder 20 of FIG. 5. Encoder 10 encodes picture 12 subdivides, e.g. by means of subdivider 23, the picture 12 into coding blocks 25 and encodes the picture 12 in units of the coding blocks, e.g. by means of encoding block 33 shown in FIG. 6. Encoder 10 encodes the partitioning information 16, which indicates the subdivision of picture 12 in the coding blocks, into the data stream 14. Encoder 10 further derives, e.g., by means of a further subdivider 27, a subdivision of the picture 12 into filtering blocks. Encoder further derives, for each of the filtering block, a respective parametrization for a filter, e.g. a filter function, for filtering the filtering block. Encoder 10 encodes the filtering information 18, which indicates the subdivision of the picture 12 into the filtering blocks into the data stream 14.

For example, encoding block 33 may comprise blocks 22, 28, 32, and 36 of FIG. 2, which may be performed block-wise, i.e. on the individual coding blocks.

For example, as the filtering information is signaled in addition to the partitioning information, the subdivision into filtering blocks may be different from the subdivision into coding blocks.

According to an embodiment, e.g. as illustrated in FIG. 2, encoder 20 is configured for encoding the picture by using a prediction signal 26 for predicting the picture 12 to obtain a residual signal 24. Encoder 10 may subject the residual signal 24 to a spatial-to-spectral transform 28 to obtain a transform signal 24′, and encoder 10 may quantize the transform signal 24′ to obtain a quantized signal 24″, and encoding the quantized signal 24″ into the data stream 14. Encoder 10 may derive the prediction signal 24 for predicting a subsequent picture of the sequence of pictures by reconstructing the picture based on the quantized signal 24″ to obtain a reconstructed picture 46. Optionally, the reconstruction is performed by dequantization 38, inverse transform 40 and combiner 42 as shown in FIG. 2. According to this embodiment, encoder 10 is configured for filtering 61 the reconstructed picture 46 by using the subdivision 18 of the picture into filtering blocks for filtering the picture. Further details described with respect to FIG. 2, e.g. details of the prediction 44, or operator 22, or encoder 34, are optional.

According to an embodiment, encoder 10 is configured for filtering 61 the reconstructed picture 46 by using a filter by using, for each of the filtering blocks, into which the reconstructed picture is subdivided according to the subdivision of the picture into filtering blocks, the respective parametrization for the filter.

According to an embodiment, encoder 10 is configured for deriving the subdivision of the picture into the filtering blocks using a rate-distortion optimization (with respect to a rate of the encoded data stream and a distortion of a reconstructed version of the picture, reconstructed from the data stream, in comparison to the original picture).

According to an embodiment, encoder 10 is configured for subdividing the picture into the filtering blocks by partitioning the picture into tree root filtering blocks, and subdividing the tree root filtering blocks using recursive tree splitting, wherein the apparatus is configured for deriving a decision whether to further split a currently processed block or to stop the recursive tree splitting using a rate-distortion optimization.

In the following, further optional details of decoder 20 of FIG. 5 and encoder 10 of FIG. 6 are described. Some features may equivalently be implemented on encoder side and on decoder side. In particular, it is to be understood that information derived from decoder 20 from the data stream 14 is to be encoded into data stream 14 by encoder 10.

According to embodiments, the encoder 10 provides the data stream 14 to be compliant to VVC, and decoder 20 is compliant to VVC.

According to an embodiment, decoder 10 is configured for filtering the picture using a filter by using, for each of the filtering blocks, a respective parametrization for the filter (e.g., using the respective parametrization for each sample position of the filtering block).

For example, decoder 20 may derive the parametrization to be used from information signaled in the data stream 14. Alternatively, decoder 20 derive the parametrization based on the respective filtering block, e.g. based on properties of the filtering block.

According to an embodiment, encoder 10 and/or decoder 20 is configured for deriving, for a coding block, e.g., a currently coded or a predetermined one, of the coding blocks (or for each of the coding blocks), a prediction mode among a plurality of prediction modes from the data stream, the prediction modes at least comprising an intra-prediction mode according to which the coding block is coded using prediction from a previously coded coding block (of the coding blocks) of the picture, and an inter-prediction mode according to which the coding block is coded using temporal prediction (e.g. prediction from a collocated coding block of a previously coded picture of the sequence of pictures).

For example, decoder 20 may comprise a prediction loop, e.g. as described with respect to FIG. 3, see prediction module 58 and combiner 56, providing a prediction loop. The prediction mode may be a mode using which prediction module 58 determines the prediction signal 26 for a current coding block. For example, as described with respect to FIG. 4, the prediction may be performed in units of the coding blocks, i.e., prediction signal 26 may be determined block-wise in units of the coding blocks, e.g. as described with respect to FIGS. 2 to 4 above. In other words, for each coding block, prediction module 58 (44 on encoder side) may determine the prediction signal 26 in dependence on the respective prediction mode, e.g. applying intra- and/or inter-prediction with respect to one or more respective reference blocks, which form a basis for the prediction, e.g., a previously coded block of the same picture or a collocated block of a previously coded picture.

Similarly, encoder 10 may comprise a prediction loop, e.g. provided by prediction stage 36 described with respect to FIG. 2.

According to an embodiment, the filtering information 18 indicates (e.g. comprises a syntax element, one possible state/value of which is indicative of) whether the subdivision 17 of the picture into filtering blocks corresponds to the subdivision 19 of the picture into the coding blocks.

Indicating that the subdivision into filtering blocks and coding blocks is the same may save bitrate for signaling the filtering blocks. Still, the flexibility of having different subdivisions is maintained.

According to an embodiment, the filtering information 18 comprises an indication of a size of the filtering blocks.

According to an embodiment, the filtering information 18 comprises a syntax element, which indicates whether a size of the filtering blocks is equal for all of the filtering blocks, and if the size of the filtering blocks is equal for all of the filtering blocks, an indication for the size of the filtering blocks.

According to an embodiment, encoder 10 and/or decoder 20 is configured for subdividing the picture into the coding blocks by partitioning the picture into tree root blocks (e.g., quadratic blocks, equally sized blocks, regularly in rows and columns, e.g., CTUs), and subdividing the tree root blocks using recursive tree splitting (e.g., each of the parent block forms a root for a splitting tree, e.g., the apparatus splits the tree root block into child blocks, each of the child blocks being input to a subsequent recursion of the recursive tree splitting to split the child blocks into child blocks of the child block, e.g., until a child block fulfils a predetermined criterion.).

For example, as described before, FIG. 4 illustrates with respect to prediction signal 26 a subdivision of the picture into tree root blocks (the regular blocks arranged in three rows and four columns in the illustrative example of FIG. 4), and a subdivision of one of the tree root blocks into four child blocks. As described with respect to FIG. 4, the child blocks may be further subdivided, e.g., as illustrated with respect to block 86 of residual signal 24″″ of FIG. 4.

According to an embodiment, encoder 10 is configured for deriving the filtering blocks in a manner that heights of the filtering blocks are equal to or lower than a height of the tree root blocks (e.g., a maximum height of the tree root blocks, or the tree root blocks have equal heights).

According to an embodiment, the filtering information 18 indicates (e.g. comprises a syntax element one possible state/value of which is indicative of) whether the subdivision 17 of the picture into the filtering blocks corresponds to the subdivision of the picture into the tree root blocks.

According to an embodiment, the filtering information 18 indicates (e.g. comprises a syntax element which is indicative of) a maximum depth of the recursive tree splitting, or a minimum block size, up to which the subdivision of the picture into filtering blocks corresponds to the subdivision of the picture into coding blocks.

Accordingly, the filtering blocks may be derived starting from a level of the recursive tree splitting performed for the coding blocks, which level is indicated by a maximum depth or a minimum block size, thus resulting in filtering blocks smaller than the tree root blocks, e.g. as illustrated in FIG. 12, which shows an example, in which tree root blocks comprise multiple filtering blocks (compare description of FIG. 12 below).

According to an embodiment, encoder 10 and/or decoder 20 is configured for further subdividing blocks of the maximum depth, or the minimum block size, based on the filtering information 18 to obtain the filtering blocks (e.g., using recursive tree splitting, e.g., until a further splitting would result in a size of the filtering blocks which is smaller than a further minimum block size which may, e.g., further be indicated in the filtering information.).

For example, as described below, the filtering blocks may be anchored at an indicated CTU split level, indicated by the maximum depth or minimum size, e.g. the coding blocks of this indicated level may be used as a starting point for deriving the filtering blocks by further splits indicated in the filtering information.

According to an embodiment, encoder 10 and/or decoder 20 is configured for subdividing the picture into the filtering blocks by partitioning the picture into tree root filtering blocks (e.g., quadratic blocks, equally sized blocks, regularly in rows and columns), and subdividing the tree root filtering blocks using recursive tree splitting (e.g., using recursive tree splitting, e.g., until a further splitting would result in a size of the filtering blocks which is smaller than a minimum size indicated in the filtering information).

That is, for example, FPU splits are anchored at a different rectangular grid than that defined by the CTU size, with smaller sizes than the CTU grid.

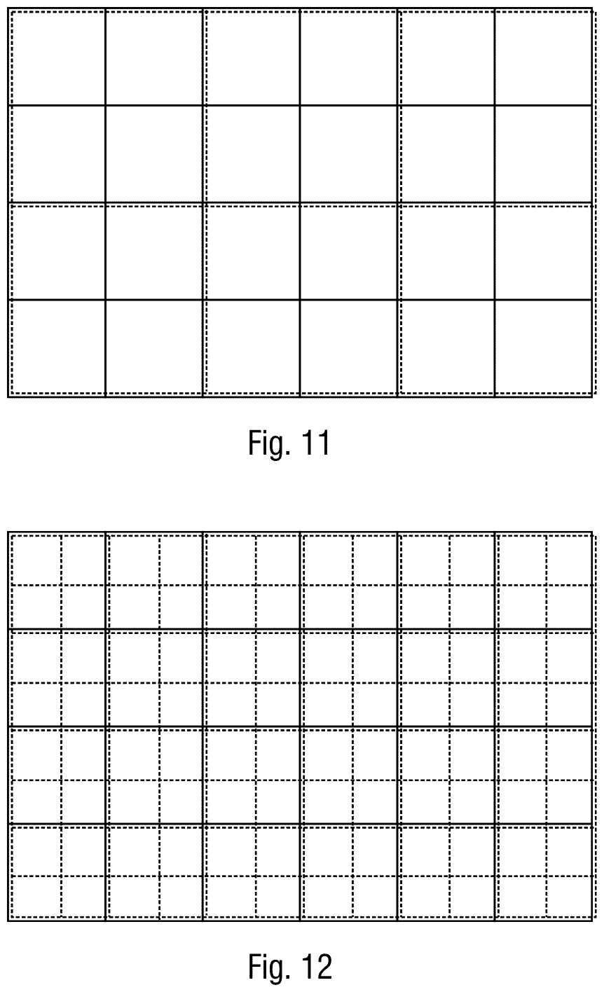

For example, the tree root filtering blocks may be larger equal or smaller than the tree root blocks, in particularly larger, thereby allowing filtering blocks being larger that the tree root blocks, so that one filtering block may include multiple tree root blocks, e.g. as illustrated in FIG. 11 (see description thereof below).

According to an embodiment, encoder 10/decoder 20 is configured for subdividing the picture into the coding blocks by partitioning the picture into tree root blocks (e.g., quadratic blocks, equally sized blocks, regularly in rows and columns, e.g., CTUs), and subdividing the tree root blocks using recursive tree splitting (e.g., each of the parent block forms a root for a splitting tree, e.g., the apparatus splits the tree root block into child blocks, each of the child blocks being input to a subsequent recursion of the recursive tree splitting to split the child blocks into child blocks of the child block, e.g., until a child block fulfils a predetermined criterion.). According to this embodiment, decoder 20 is configured for, in the recursive tree splitting of the tree root filtering blocks, if a block resulting from the recursive tree splitting of the tree root filtering blocks (e.g., referred to as child filtering block, e.g., resulting from a split of one of the tree root filtering blocks, or from a split of a child filtering block thereof, or a child filtering block resulting from any recursion of the recursive tree splitting) coincides with one of the tree root blocks, splitting the block into child filtering blocks along the recursive tree splitting of the one tree root block up to a maximum depth or minimum block size.

For example, decoder 20 may assume by default, or may derive from an indication in the data stream 14, that the subdivision into filtering blocks is different from the subdivision into coding blocks. In case of a coincidence of a filtering block with a coding block, this information may be exploited by decoder 20 by further subdividing the filtering block, e.g. without an explicit signaling in the data stream 14. Accordingly, bitrate savings are achieved compared to an explicit signaling of this split.

According to an alternative embodiment, decoder 20 is configured for deriving a syntax element from the data stream, which indicates, whether to split, in the recursive tree splitting of the tree root filtering blocks, a block resulting from the recursive tree splitting of the tree root filtering blocks, which coincides with one of the tree root blocks, along the recursive tree splitting of the one tree root block into coding blocks. If the syntax element indicates to split, in the recursive tree splitting of the tree root filtering blocks, a block resulting from the recursive tree splitting of the tree root filtering blocks, which coincides with one of the tree root blocks, along the recursive tree splitting of the one tree root block into coding blocks, decoder 20 may, in the recursive tree splitting of the tree root filtering blocks, split the block into child filtering blocks along the recursive tree splitting of the one tree root block up to a maximum depth or minimum block size, if a block resulting from the recursive tree splitting of the tree root filtering blocks (e.g., a child filtering block resulting from a split of one of the tree root filtering blocks, or from a split of a child filtering block thereof, or a child filtering block resulting from any recursion of the recursive tree splitting) coincides with one or the tree root blocks. According to an embodiment, encoder 10 encodes the syntax element into the data stream 14.

According to embodiments, decoder 20 is configured for, in the recursive tree splitting for obtaining the filtering blocks, further subdividing blocks of the maximum depth, or the minimum block size, based on the filtering information to obtain the filtering blocks (e.g., using recursive tree splitting, e.g., until a further splitting would result in a size of the filtering blocks which is smaller than a further minimum block size which may, e.g., further be indicated in the filtering information.).

According to an embodiment, encoder 10 is configured for, encoding, into the data stream (e.g., into the filtering information), information about a further subdivision of blocks of the maximum depth, or the minimum block size in the recursive tree splitting for obtaining the filtering blocks.

According to an alternative embodiment, encoder 10/decoder 20 is configured for, in the recursive tree splitting of the tree root filtering blocks, if a block resulting from the recursive tree splitting of the tree root filtering blocks (e.g., referred to as child filtering block, e.g., resulting from a split of one of the tree root filtering blocks, or from a split of a child filtering block thereof, or a child filtering block resulting from any recursion of the recursive tree splitting) coincides with one or the coding blocks, stopping the recursive tree splitting of the block and using the block as one of the filtering blocks.

According to an alternative embodiment, encoder 10/decoder 20 is configured for subdividing the picture into the coding blocks by partitioning the picture into tree root blocks (e.g., quadratic blocks, equally sized blocks, regularly in rows and columns, e.g., CTUs), and subdividing the tree root blocks using recursive tree splitting (e.g., each of the parent block forms a root for a splitting tree, e.g., the apparatus splits the tree root block into child blocks, each of the child blocks being input to a subsequent recursion of the recursive tree splitting to split the child blocks into child blocks of the child block, e.g., until a child block fulfils a predetermined criterion.). According to this embodiment, in the recursive tree splitting of the tree root filtering blocks, if a block resulting from the recursive tree splitting of the tree root filtering blocks (e.g., referred to as child filtering block, e.g., resulting from a split of one of the tree root filtering blocks, or from a split of a child filtering block thereof, or a child filtering block resulting from any recursion of the recursive tree splitting) coincides with one of the tree root blocks, decoder 20 splits the block into filtering blocks in line with the subdivision of the picture into coding blocks so that each filtering block within the block corresponds to a coding block.

Accordingly, this embodiments allows a flexible subdivision into filtering blocks independent from the coding blocks for filtering blocks being larger than the tree root blocks, but, in case that the filtering blocks are chosen equal or smaller than the tree root blocks, the subdivision into coding blocks may be used. This way, the comparably high signaling overhead for signaling a subdivision of high granularity may be avoided for the filtering blocks while still providing the possibility of a subdivision into filtering blocks of high granularity. In particular, this embodiment exploits the idea that the cases, in which small-sized coding blocks are beneficial may to some extent overlap with the cases, in which small-sized filtering blocks are beneficial.

According to an embodiment, encoder 10 is configured for, in deriving the filtering blocks, obeying a constraint (e.g. based on a bitstream constraint, associated with a current operation of the apparatus, or which is signaled in the data stream to be obeyed) that a height of the filtering blocks is equal to or lower than a height of the tree root blocks.

According to an embodiment, decoder 20 is configured for deriving, from the data stream, a syntax element (e.g., from the syntax structure defined below, e.g., in a SPS of PPS) which indicates (e.g. based on a bitstream constraint, associated with a current operation of the apparatus, or which is signaled in the data stream to be obeyed) that a height of the filtering blocks is equal to or lower than a height of the tree root blocks.

For example, decoder 20 may perform the subdivision into the filtering blocks up to a subdivision into blocks having an equal or smaller height than the tree root blocks without filtering information from the data stream.

According to an embodiment, encoder 10 is configured for deriving the filtering blocks in a manner that one or both of
one tree root block comprising an integer number of filtering blocks, and
one filtering block comprising an integer number of tree root blocks
   is fulfilled (e.g. in splitting the tree root filtering blocks).

According to an embodiment, encoder 10 is configured for, encoding, into the data stream, an indication which indicates that, for all pictures of the sequence, one or both of
one tree root block comprising an integer number of filtering blocks, and
one filtering block comprising an integer number of tree root blocks
   is fulfilled.

According to an embodiment, decoder 20 is configured for, checking whether the data stream indicates that, for all pictures of the sequence, one or both of
one tree root block comprising an integer number of filtering blocks, and
one filtering block comprising an integer number of tree root blocks
   is fulfilled (e.g., such that the apparatus may process multiple CTUs or multiple FPUs in parallel).

According to an embodiment, decoder 20 is configured for deriving, from the data stream, a syntax structure comprising an indication, which indicates whether the subdivision 17 of the picture into filtering blocks corresponds to the subdivision of the picture into the tree root blocks, wherein the syntax structure refers to (e.g., is valid for)
all pictures of the sequence of pictures (e.g., the syntax structure is a sequence parameter set, SPS),
one or more of the pictures of the sequence of pictures (e.g., the syntax structure is a picture parameter set, PPS, or a picture header, or an adaptive parameter set, APS),
all subsequent pictures of the sequence of pictures,
one (e.g., exactly one) slice of slices into which the pictures are partitioned.

According to an embodiment, encoder 10 is configured for encoding the syntax structure into descriptive data of the data stream, which precedes, or is interspersed with, payload packets carrying the pictures.

According to an embodiment, decoder 20 is configured for deriving the syntax structure from descriptive data of the data stream, which precedes, or is interspersed with, payload packets carrying (e.g. having the samples of the picture encoded thereinto) the pictures.

According to an embodiment, if the syntax structure indicates that the subdivision of the picture into the filtering blocks does not correspond to the subdivision of the picture into the tree root blocks, the syntax structure further comprises an indication of a maximum size of the filtering blocks and, optionally, an indication of a minimum size of the filtering blocks, e.g., as in the embodiment of Table 1 below.

According to an embodiment, the filtering information comprises an indication of a maximum size of the filtering blocks and, optionally, an indication of a minimum size of the filtering blocks.

According to an embodiment, encoder 10/decoder 20 is configured for deriving the filtering blocks using a recursive tree splitting by splitting a block of the picture (e.g., a coding block, or a block resulting from a recursion of the recursive tree splitting for obtaining the coding blocks, or one of tree root filtering blocks into which the picture is subdivided for obtaining the filtering blocks) into child filtering blocks, each of the child filtering blocks being input to a subsequent recursion of the recursive tree splitting to split the child filtering block into child filtering blocks of the child filtering block until a child filtering block fulfils a predetermined criterion (e.g., until the data stream indicates to stop the recursive splitting, or until the minimum size for the filtering blocks is reached or exceeded, or would be exceeded in case of a further split; E.g, the apparatus splits the block until the child blocks have a size equal to or smaller than the maximum size, and for each block having a size equal to or smaller than the maximum size, check whether a split of the block would result in a size smaller than the minimum size, and if so, stop the recursive splitting, and if not, check whether there is an indication in the data stream which indicates whether to split or not to split the block, and decide whether to split or not to split the block in dependence on the indication.). For example, in case of the encoder, the predetermined criterion may be a rate-distortion optimization criterion.

According to an alternative embodiment, decoder 20 is configured for deriving the filtering blocks by subdividing the picture into tree root filtering blocks of the maximum size (e.g., rectangular or quadratic blocks, e.g., equally sized except for blocks at the right or the lower border of the picture), and subdividing a tree root filtering block of the tree root filtering blocks (e.g., each of the tree root filtering blocks), by performing a recursive tree splitting. Decoder 20 may perform the recursive tree splitting by deriving an indication (e.g., a syntax element, e.g. flag having two states, e.g., from the data stream) which indicates whether the tree root filtering block is to be split. If the tree root filtering block is to be split, decoder 20 may split the tree root filtering block into child filtering blocks, each of the child filtering blocks being input to a subsequent recursion of the recursive tree splitting (and if the tree root filtering block is not to be split, stop the recursive tree splitting).

According to an embodiment, encoder 10 is configured for encoding a syntax element into the data stream, which indicates, whether to split, in the recursive tree splitting of the tree root filtering blocks, a block resulting from the recursive tree splitting of the tree root filtering blocks, which coincides with one of the tree root blocks, along the recursive tree splitting of the one tree root block into coding blocks.

According to an embodiment, decoder 20 is configured for, in the recursive tree splitting of the tree root filtering blocks, if a block resulting from the recursive tree splitting of the tree root filtering blocks (e.g., referred to as child filtering block, e.g., resulting from a split of one of the tree root filtering blocks, or from a split of a child filtering block thereof, or a child filtering block resulting from any recursion of the recursive tree splitting) coincides with one or the tree root blocks, splitting the block into child filtering blocks along the recursive tree splitting of the one tree root block up to a maximum depth or minimum block size.

According to an alternative embodiment, decoder 20 is configured for deriving a syntax element from the data stream, which indicates, whether to split, in the recursive tree splitting of the tree root filtering blocks, a block resulting from the recursive tree splitting of the tree root filtering blocks, which coincides with one of the tree root blocks, along the recursive tree splitting of the one tree root block into coding blocks. If the syntax element indicates to split, in the recursive tree splitting of the tree root filtering blocks, a block resulting from the recursive tree splitting of the tree root filtering blocks, which coincides with one of the tree root blocks, along the recursive tree splitting of the one tree root block into coding blocks, decoder 20 may, in the recursive tree splitting of the tree root filtering blocks, split the block into child filtering blocks along the recursive tree splitting of the one tree root block up to a maximum depth or minimum block size, if a block resulting from the recursive tree splitting of the tree root filtering blocks (e.g., a child filtering block resulting from a split of one of the tree root filtering blocks, or from a split of a child filtering block thereof, or a child filtering block resulting from any recursion of the recursive tree splitting) coincides with one or the tree root blocks. According to an embodiment, encoder 10 derives the syntax element, e.g. based on a rate-distortion criterion, and, e.g., encodes the syntax element into the data stream.

According to an embodiment, encoder 10/decoder 20 is configured for, in the recursive tree splitting for obtaining the filtering blocks, further subdividing blocks of the maximum depth, or the minimum block size, based on the filtering information to obtain the filtering blocks (e.g., using recursive tree splitting, e.g., until a further splitting would result in a size of the filtering blocks which is smaller than a further minimum block size which may, e.g., further be indicated in the filtering information.).

According to an embodiment, decoder 20 is configured for deriving a syntax element from the data stream, which indicates, whether to split, in the recursive tree splitting of the tree froot filtering blocks, a block resulting from the recursive tree splitting of the tree root filtering blocks, which coincides with one of the tree root blocks, along the recursive tree splitting of the one tree root block into coding blocks. If the syntax element indicates to split, in the recursive tree splitting of the tree root filtering blocks, a block resulting from the recursive tree splitting of the tree root filtering blocks, which coincides with one of the tree root blocks, along the recursive tree splitting of the one tree root block into coding blocks, decoder 20 splits, in the recursive tree splitting of the tree root filtering blocks, the block into filtering blocks in line with the subdivision of the picture into coding blocks so that each filtering block within the block corresponds to a coding block, if a block resulting from the recursive tree splitting of the tree root filtering blocks (e.g., a child filtering block resulting from a split of one of the tree root filtering blocks, or from a split of a child filtering block thereof, or a child filtering block resulting from any recursion of the recursive tree splitting) coincides with one or the tree root blocks. According to an embodiment, encoder 10 derives the syntax element, e.g. based on a rate-distortion criterion, and, e.g., encodes the syntax element into the data stream.

According to an embodiment, if the syntax structure indicates that the subdivision of the picture into the filtering blocks does not correspond to the subdivision of the picture into the tree root blocks, the syntax structure further indicates (e.g., comprises a syntax element, which indicates), whether a size of the filtering blocks is equal for all of the filtering blocks, and if the size of the filtering blocks is equal for all of the filtering blocks, an indication for the size of the filtering blocks, e.g. as in the embodiment of Table 2 below, see, e.g., sps_adaptive_fpu_flag.

According to an embodiment, encoder 10 is configured for, if the subdivision of the picture into the filtering blocks does not correspond to the subdivision of the picture into the tree root blocks, encoding into the syntax structure an indication which indicates, whether a size of the filtering blocks is equal for all of the filtering blocks, and if the size of the filtering blocks is equal for all of the filtering blocks, an indication of the size of the filtering blocks.

According to an embodiment, if the syntax structure indicates that the size of the filtering blocks is not equal for all of the filtering blocks, the syntax structure comprises an indication of a maximum size of the filtering blocks and a minimum size of the filtering blocks.

According to an embodiment, (e.g., as in the embodiment of Table 3) the syntax structure indicates which one of a set of options applies, the set of options comprising one or more or all of:
the subdivision of the picture into the filtering blocks corresponding to the subdivision of the picture into the tree root blocks,
a size of the filtering blocks being equal for all of the filtering blocks,
the data stream (e.g., the syntax structure) comprising a signalization of sizes of the filtering blocks, which signalization is specific to a picture or a portion of a picture, and
the subdivision of the picture into filtering blocks corresponding to the subdivision of the picture into the coding blocks.

According to an embodiment, the syntax structure indicates whether the data stream comprises a signalization of sizes of the filtering blocks, and wherein the decoder 20 is configured for, if the syntax structure indicates that the data stream comprises a signalization of sizes of the filtering blocks, deriving a size and/or a position of a filtering block by deriving, from the data stream, (e.g., from the syntax structure or a further syntax structure, e.g., syntax structure relating to the sequence of pictures and the further syntax structure being specific to a picture or a portion of a picture)
an indication of a relative size of the filtering block with respect to a size of the tree root blocks,
an indication of a relative size of the filtering block with respect to a maximum size for the tree root blocks,
an indication of a relative size of the filtering block with respect to a maximum size for the filtering blocks,
an indication, which indicates whether the size of the filtering block is smaller or larger than or equal to a size of the tree root blocks, and if the filtering block is larger than the tree root blocks, an indication of a number of tree root blocks included in the filtering block, and if the filtering block is smaller than the tree root blocks, an indication of the size of the filtering block (e.g., indicated in a number of luma samples).

According to an embodiment, encoder 10 is configured for encoding into the syntax structure an indication, which indicates whether the data stream comprises a signalization of sizes of the filtering blocks, and wherein the apparatus is configured for, if the syntax structure indicates that the data stream comprises a signalization of sizes of the filtering blocks, encoding an indication of a size and/or a position of a filtering block into the data stream, (e.g., from the syntax structure or a further syntax structure, e.g., syntax structure relating to the sequence of pictures and the further syntax structure being specific to a picture or a portion of a picture)
an indication of a relative size of the filtering block with respect to a size of the tree root blocks,
an indication of a relative size of the filtering block with respect to a maximum size for the tree root blocks,
an indication of a relative size of the filtering block with respect to a maximum size for the filtering blocks,
an indication, which indicates whether the size of the filtering block is smaller or larger than or equal to a size of the tree root blocks, and if the filtering block is larger than the tree root blocks, an indication of a number of tree root blocks included in the filtering block, and if the filtering block is smaller than the tree root blocks, an indication of the size of the filtering block (e.g., indicated in a number of luma samples).

According to an embodiment, decoder 20 is configured for deriving, from the data stream, a syntax structure, which relates to one or more or to all pictures of the sequence, and which is indicative of a plurality of filtering block size indications. According to this embodiment, decoder 20 selects, for a picture, or a portion of a picture, one of the filtering block size indications by deriving, from the data stream, an indication, which associates the filtering block with one of the filtering block size indications. E.g., the embodiment may be implemented as described with respect to Tables 14 an 15.

According to an embodiment, encoder 10 is configured for encoding, into the data stream, a syntax structure, which relates to one or more or to all pictures of the sequence, and which is indicative of a plurality of filtering block size indications, and configured for encoding, for a picture, or a portion of a picture, an indication to the data stream, which indication associates the filtering block with one of the filtering block size indications.

According to an embodiment, the indication, which associates the filtering block with one of the filtering block size indications, is included in
syntax structure, which is indicative of the set of filtering block size indications,
a syntax structure, which relates to one or more or to all pictures of the sequence (e.g., a SPS or a PPS), or
a syntax structure which relates to exactly one picture (e.g., a picture header), or a portion of one picture (e.g., a slice header).

According to an embodiment, encoder 10 is configured for encoding the indication, which associates the filtering block with one of the filtering block size indications, into
syntax structure, which is indicative of the set of filtering block size indications,
a syntax structure, which relates to one or more or to all pictures of the sequence (e.g., a SPS or a PPS), or
a syntax structure which relates to exactly one picture (e.g., a picture header), or a portion of one picture (e.g., a slice header).

According to an embodiment, each of the filtering block size indications comprises an indication of a maximum size of the filtering blocks and, optionally, an indication of a minimum size of the filtering blocks. According to an alternative embodiment, each of the filtering block size indications comprises an indication of a size of the filtering blocks (e.g., a unitary size for all filtering blocks within the scope of the filtering size block indication).

According to an embodiment, decoder 20 is configured for filtering the picture using a filter by using, for each of the filtering blocks, a respective parametrization for the filter. According to this embodiment, decoder 20 is configured for filtering the picture using a further filter, and deriving, from the data stream, an indication which indicates whether further filtering blocks for the further filter coincide with the filtering blocks for the filter (and, e.g., using, for each of the further filtering blocks for the further filter, a respective parametrization for the further filter).

For example, the filtering and the further filtering may be performed by filtering block 62. For example, the further filtering may be performed after the filtering, e.g. on an output of the filtering.

Similarly, on encoder side, encoder 10, according to an embodiment, is configured for filtering the reconstructed picture 46 by filtering the reconstructed picture using a filter by using, for each of the filtering blocks, a respective parametrization for the filter, and filtering the reconstructed picture using a further filter, and encoding, into the data stream, an indication which indicates whether further filtering blocks for the further filter coincide with the filtering blocks for the filter (and, e.g., using, for each of the further filtering blocks for the further filter, a respective parametrization for the further filter). For example, the filtering and the further filtering may be performed by block 61. For example, the further filtering may be performed after the filtering, e.g. on an output of the filtering.

According to an embodiment, encoder 10/decoder 20 is configured for deriving the filtering blocks using a recursive tree splitting, and, if the further filtering blocks for the further filter do not coincide with the filtering blocks for the filter, derive an indication from the data stream, which indicates whether the further filtering blocks coincide with the filtering blocks up to a certain depth of the recursive tree splitting (and if so, derive the further filtering blocks by recursively subdividing blocks of the certain depth of the recursive tree splitting based on the filtering information to obtain the further filtering blocks).

According to an embodiment, decoder 20 is configured for deriving the filtering blocks using a recursive tree splitting, and, if the further filtering blocks for the further filter do not coincide with the filtering blocks for the filter, derive information about a size of the further filtering blocks from the data stream (e.g., a size of the further filtering blocks, or a maximum size (and, optionally a minimum size) for performing a recursive tree splitting for the further filter; E.g. the information about the size of the further filtering blocks may be signaled equivalent as defined for the filtering blocks).

According to an embodiment, decoder 20 is configured for filtering the picture using a filter by using, for each of the filtering blocks, a respective parametrization for the filter. Encoder 10 may filter the reconstructed picture 46 by filtering the reconstructed picture using a filter by using, for each of the filtering blocks, the respective parametrization for the filter. The respective parametrization comprises one or more of
a filter template (e.g., defining sample positions relative to a scan position of the filtering block, based on which sample positions a filtered value for the scan position is determined, e.g., the filtering is performed by determining, according to a scan order, for each sample position of the picture, a filtered value),
a set of one or more filter coefficients (e.g., filter coefficients for a filter template, e.g., for positions of the filter template),
an activation or deactivation of the filter.

According to an embodiment, decoder 20 is configured for filtering the picture by using one of (e.g. filtering the picture in units of the filtering blocky, by applying, to each of the filtering blocks, a filter, the filter being one of) an adaptive loop filter (ALF), a deblocking filter (DBF), a luma mapping chroma sampling (LMCS) filter, a sample adaptive offset (SAO) filter, and a neural network.

Similarly, encoder 10 may filter the reconstructed picture by filtering the reconstructed picture using a filter by using, for each of the filtering blocks, a respective parametrization for the filter, wherein the filter is one of an adaptive loop filter (ALF), a deblocking filter (DBF), a luma mapping chroma sampling (LMCS) filter, a sample adaptive offset (SAO) filter, and a neural network.

According to an embodiment, the filter is an adaptive loop filter (ALF), and the respective parametrization comprises a set of filter coefficients for a filter template.

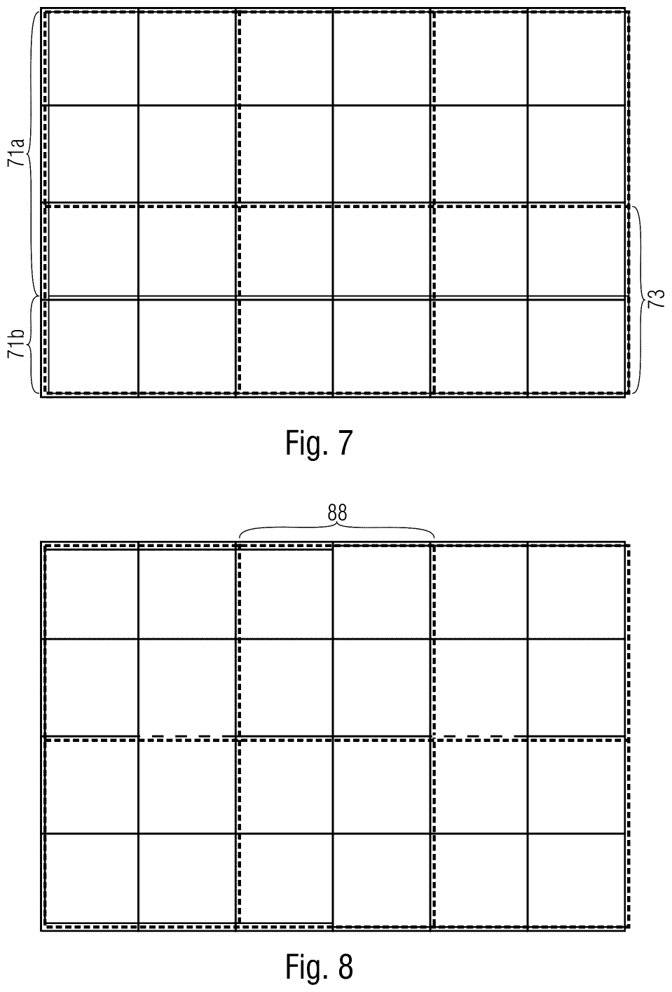

FIG. 7 illustrates an example of a subdivision of a picture into tree root blocks, filtering blocks, and slices. In FIG. 7, tree root blocks are indicated in solid lines, i.e. in the example of FIG. 7, the picture is subdivided into 4 rows and 6 columns of tree root blocks, and the filtering blocks are indicated in dashed lines, i.e., in the illustrative example of FIG. 7, each filtering block comprises four tree root blocks. In the illustrative example of FIG. 7, the picture is subdivided into two slices 71a, 71b, slice 71a covering the tree root blocks of the upper three rows, and slice 71b covering the tree root blocks of the lower row. In the scenario of FIG. 7, filtering blocks of filtering block row 73 cross the boundary between two slices.

According to embodiments described in the following, decoder 20 may be sensitive to whether or not filtering blocks cross slice boundaries, or decoder 20 may exploit an information indicating a relation between boundaries of slices and filtering block, e.g. in the subdivisioning of the filtering blocks or with respect to an independent decoding of slices.

According to embodiments described in the following, encoder 10 and/or decoder 20 is configured for subdividing the picture into the coding blocks by partitioning the picture into tree root blocks, and subdividing the tree root blocks using recursive tree splitting, and decoder 20 is further configured for decoding the picture in units of slices, into which the picture is subdivided in a manner that each slice comprises one or more of the tree root blocks.

According to an embodiment, encoder 10/decoder 20 is configured for decoding the picture in units of slices, into which the picture is subdivided in a manner that each slice comprises one or more (e.g., entire) rows of the tree root blocks, e.g. as illustrated in FIG. 7. According to this embodiment, decoder 20 is configured for checking whether the data stream indicates (e.g. comprises a syntax element, e.g. a binary syntax element, one possible state/value of which is indicative of) that, for all pictures of the sequence, heights of all of the slices, or heights of all of the slices except for respective last slice of the pictures, are integer multiples of a height of the filtering blocks (e.g., a maximum height of the filtering blocks) (If the check yields that the heights of the slices are integer multiples of the height of the filtering blocks, the apparatus may exploit that slices (or tiles or subpictures as in the following claims) are decodable independently from each other. E.g., the apparatus may decode multiple slices in parallel, or may extract a portion of the data stream signaling a portion of a picture, e.g., without the need of gathering information about the filtering from another slice). Encoder 10 may be configured for indicating in the data stream whether, for all pictures of the sequence, heights of all of the slices, or heights of all of the slices except for respective last slices of the pictures, are integer multiples of a height of the filtering blocks (e.g., a maximum height of the filtering blocks).

According to an alternative embodiment, decoder 20 is configured for checking whether the data stream indicates (e.g. comprises a syntax element, e.g. a binary syntax element, one possible state/value of which is indicative of) that, for all pictures of the sequence, all borders of each of the filtering blocks coincide with borders of one or more slices. Encoder 10 may be configured for indicating in the data stream whether, for all pictures of the sequence, all borders of each of the filtering blocks coincide with borders of one or more slices.

In other words, the data stream 14 may indicate that each filtering block comprises one or more entire slices.

According to an alternative embodiment, decoder 20 is configured for checking whether the data stream indicates (e.g. comprises a syntax element, e.g. a binary syntax element, one possible state/value of which is indicative of) that, for all pictures of the sequence, each of the slices comprises one or more filtering blocks, and each filtering block is located within one of the slices. Encoder 10 may be configured for indicating in the data stream whether, for all pictures of the sequence, each of the slices comprises one or more filtering blocks, and each filtering block is located within one of the slices.

According to an alternative embodiment (in which, optionally, each slice comprises one or more (entire) rows of tree root blocks) decoder 20 is configured for checking, whether the data stream comprises an indication which indicates (e.g. comprises a syntax element, e.g. a binary syntax element, one possible state/value of which is indicative of) whether filtering blocks are restricted to be located within one slice. Encoder 10 may be configured for indicating in the data stream whether filtering blocks are restricted to be located within one slice. If the filtering blocks are indicated to be restricted to be located within one slice, decoder 20 and/or encoder 10 derives the filtering blocks by splitting the filtering blocks at slice boundaries (and if the filtering blocks are not indicated to be restricted to be located within one slice, deriving the filtering blocks by not splitting the filtering blocks at slice boundaries unless a condition for splitting a filtering block at a slice boundary is fulfilled, e.g. according to a general rule for deriving the filtering blocks).

According to an alternative embodiment (in which, optionally, each slice comprises one or more (entire) rows of tree root blocks) encoder 10 and/or decoder 20 is configured for deriving the filtering blocks by splitting the filtering blocks at slice boundaries.

FIG. 8 illustrates an example of a subdivision of a picture into tree root blocks, filtering blocks, and portions, e.g., tiles or subpictures. In FIG. 8, tree root blocks are indicated in solid lines, i.e. in the example of FIG. 8, the picture is subdivided into 4 rows and 6 columns of tree root blocks, and the filtering blocks are indicated in dashed lines, i.e., in the illustrative example of FIG. 8, each filtering block comprises four tree root blocks. In the illustrative example of FIG. 8, the picture is subdivided into two portions 81a, 81b, portion 81a covering the tree root blocks of the left three columns, and portion 81b covering the tree root blocks of the right three columns. In the scenario of FIG. 8, filtering blocks of filtering block column 88 cross the boundary between two slices.

According to embodiments described in the following, encoder 10 and/or decoder 20 is configured for subdividing the picture into the coding blocks by partitioning the picture into tree root blocks, and subdividing the tree root blocks using recursive tree splitting, and further configured for decoding the picture in units of portions (e.g., tiles or subpictures), into which the picture is subdivided in a manner that each portion comprises one or more of the tree root blocks.

According to an embodiment, the portions are rectangular, and the decoder 20 is configured for checking whether the data stream indicates (e.g. comprises a syntax element, e.g. a binary syntax element, one possible state/value of which is indicative of) that, for all pictures of the sequence, heights of
all of the portions, or
all of the portions except for portions being located at a lower border of one of the pictures
   are integer multiples of a height of the filtering blocks (e.g., a maximum height of the filtering blocks), and widths of
all of the portions, or
all of the portions except for portions being located at a right border of one of the pictures
   are integer multiples of a width of the filtering blocks (e.g., a maximum height of the filtering blocks) (e.g. in any combination of the OR-options).

According to an embodiment, encoder 10 may be configured for indicating in the data stream whether, for all pictures of the sequence, heights of
all of the portions, or
all of the portions except for portions being located at a lower border of one of the pictures
   are integer multiples of a height of the filtering blocks (e.g., a maximum height of the filtering blocks), and widths of
all of the portions, or
all of the portions except for portions being located at a right border of one of the pictures
   are integer multiples of a width of the filtering blocks (e.g., a maximum height of the filtering blocks).

According to an embodiment, the decoder 20 is configured for checking whether the data stream indicates (e.g. comprises a syntax element, e.g. a binary syntax element, one possible state/value of which is indicative of) that, for all pictures of the sequence, each of the portions comprises one or more filtering blocks, and each filtering block is located within one of the portions. Encoder 10 may be configured for indicating in the data stream whether, for all pictures of the sequence, each of the portions comprises one or more filtering blocks, and each filtering block is located within one of the portions.

According to an embodiment, the decoder 20 is configured for checking whether the data stream comprises an indication which indicates (e.g. comprises a syntax element, e.g. a binary syntax element, one possible state/value of which is indicative of) whether filtering blocks are restricted to be located within one portion. Encoder 10 may be configured for indicating in the data stream whether filtering blocks are restricted to be located within one portion. If the filtering blocks are indicated to be restricted to be located within one portion, encoder 10/decoder 20 derives the filtering blocks by splitting the filtering blocks at portion boundaries (and if the filtering blocks are not indicated to be restricted to be located within one portion, deriving the filtering blocks by not splitting the filtering blocks at portion boundaries unless a condition for splitting a filtering block at a portion boundary is fulfilled, e.g. the data stream includes an indication whether to split or nor to split a filtering block at the respective position).

Continuing the description of FIG. 5, the following embodiments may be combined with any of the previous embodiments described with respect to FIGS. 5 to 8.

According to an embodiment, decoder 20 is configured for filtering the picture (and encoder 10 configured for filtering the reconstructed picture 46) using a filter by using, for each of the filtering blocks, a respective parametrization for the filter. According to this embodiment, decoder 20 is further configured for subdividing the picture into the coding blocks by partitioning the picture into tree root blocks, and subdividing the tree root blocks using recursive tree splitting. If a filtering block of the filtering blocks comprises one or more of the tree root blocks, decoder 20 derives, from the data stream 14 (encoder 10 encodes into the data stream),
an indication of the parametrization for the filter signaled for a first tree root block (e.g., signaled within a syntax structure, into which sample values of the tree root block are coded; E.g., the apparatus 20 derives the parametrization from this syntax structure) of the one or more tree root blocks according to a coding order of among the one or more tree root blocks, and using the parametrization signaled for the first tree root block for the filtering of the (all of the) one or more tree root blocks, or
an indication of the parametrization for the filter signaled for a last tree root block (e.g., signaled within a syntax structure, into which sample values of the tree root block are coded; E.g., the apparatus 20 derives the parametrization from this syntax structure) of the one or more tree root blocks according to a coding order of among the one or more tree root blocks, and using the parametrization signaled for the last tree root block for the filtering of the (all of the) one or more tree root blocks, or
an indication of the parametrization for the filter signaled for a first tree root block (e.g., signaled within a syntax structure, into which sample values of the tree root block are coded; E.g., the apparatus derives the parametrization from this syntax structure) of the one or more tree root blocks in a coding order of among the one or more tree root blocks which fulfills a predetermined condition (E.g., the predetermined condition is one or a combination of the tree root block being encoded in inter-mode, or intra-mode, not skip-mode, has at least a predetermined number of CUs, has more than a predetermined number of non-zero coefficients), and using the parametrization signaled for the first tree root block which fulfills the predetermined condition for the filtering of the (all of the) one or more tree root blocks, or
a syntax structure (e.g., a syntax structure being interspersed between syntax structures, into which tree root blocks are coded, i.e. into which sample values of the tree root blocks are coded; e.g., a syntax structure on a syntax level of tree root blocks; e.g., a syntax structure which is valid for, or relates to, a plurality of tree root blocks; e.g., the syntax structure is signaled before the first tree root block, or after the last tree root block of the filtering block) comprising an indication of the parametrization for the filter, and using the parametrization for the filtering of the tree root blocks of the filtering block (e.g., the syntax structure further comprises the filtering information or part thereof).

According to an embodiment, decoder 20 is configured for filtering the picture (and encoder 10 is configured for filtering the reconstructed picture 46) using a filter by using, for each of the filtering blocks, a respective parametrization for the filter. According to this embodiment, encoder 10 and/or decoder 20 is configured for subdividing the picture into the coding blocks by partitioning the picture into tree root blocks, and subdividing the tree root blocks using recursive tree splitting, and further configured for decoding the picture in units of portions (e.g., slices (e.g., covering one or more entire rows of tree root blocks), tiles or subpictures), into which the picture is subdivided in a manner that each portion comprises one or more of the tree root blocks, wherein the portions are rectangular. If a filtering block of the filtering blocks comprises a plurality of tree root blocks distributed over a plurality of the portions, decoder 20 derives, for each of the portions comprising one of the tree root blocks of the filtering block, from the data stream (and encoder 10 encodes, for each of the portions comprising one of the tree root blocks of the filtering block, into the data stream), an indication of the parametrization for the filter signaled for a first tree root block, or a last tree root block, (e.g., signaled within a syntax structure, into which sample values of the tree root block are coded; E.g., the decoder 20 derives the parametrization from this syntax structure) according to a coding order among tree root blocks, which belong to the filtering block and the portion, and using the parametrization signaled for the first tree root block, or the last tree root block, for the filtering the (e.g., all of the) tree root blocks, which belong to the filtering block and the portion.

According to an embodiment, decoder 20 is, configured for filtering the picture using a filter by using, for each of the filtering blocks, a respective parametrization for the filter. According to this embodiment, decoder 20 subdivides the picture into the coding blocks by partitioning the picture into tree root blocks, and subdividing the tree root blocks using recursive tree splitting, and further configured for decoding the picture in units of portions (e.g., slices (e.g., covering one or more entire rows of tree root blocks), tiles or subpictures), into which the picture is subdivided in a manner that each portion comprises one or more of the tree root blocks, wherein the portions are rectangular. If a filtering block of the filtering blocks comprises one or more of the tree root blocks, decoder 20 checks, for one of (or for each of) the tree root blocks of the filtering block, the tree root block belonging to one of the portions, if the tree root block fulfills a predetermined criterion (E.g., the predetermined condition is one or a combination of the tree root block being encoded in inter-mode, or intra-mode, not skip-mode, has at least a predetermined number of CUs, has more than a predetermined number of non-zero coefficients). If the tree root block fulfills the predetermined criterion, decoder 20 derives, from the data stream, an indication of the parametrization for the filter signaled for the tree root block (e.g., signaled within a syntax structure, into which sample values of the tree root block are coded; E.g., the apparatus derives the parametrization from this syntax structure) and using the parametrization for tree root blocks (e.g., each of, or all tree root blocks), which belong to the filtering block and to the one portion. If the tree root block does not fulfill the predetermined criterion, decoder 20 uses the parametrization for the filter signaled for a further tree root block, which belongs to the filtering block and the one portion (e.g., a previous tree root block or a subsequent filtering block in the coding order fulfilling the criterion), for filtering the tree root block. If none of the tree root blocks of the filtering block, which tree root blocks belong to the one portion, fulfills the predetermined criterion, decoder 20 uses a predetermined parametrization (e.g. a parametrization from another portion) for the filter for filtering the tree root block.

Similarly, according to an embodiment, encoder 10 is configured for filtering the picture, e.g. the reconstructed picture 46, using a filter by using, for each of the filtering blocks, a respective parametrization for the filter. Encoder 10 may subdivide the picture into the coding blocks by partitioning the picture into tree root blocks, and subdividing the tree root blocks using recursive tree splitting, and further configured for encoding the picture in units of portions (e.g., slices (e.g., covering one or more entire rows of tree root blocks), tiles or subpictures), into which the picture is subdivided in a manner that each portion comprises one or more of the tree root blocks, wherein the portions are rectangular. If a filtering block of the filtering blocks comprises one or more of the tree root blocks, encoder 10 may check, for one of (or for each of) the tree root blocks of the filtering block, the tree root block belonging to one of the portions, if the tree root block fulfills a predetermined criterion (E.g., the predetermined condition is one or a combination of the tree root block being encoded in inter-mode, or intra-mode, not skip-mode, has at least a predetermined number of CUs, has more than a predetermined number of non-zero coefficients). If the tree root block fulfills the predetermined criterion, encoder 10 may encode, into the data stream, an indication of the parametrization for the filter for the tree root block (e.g., in a syntax structure, into which sample values of the tree root block are coded; E.g., the apparatus derives the parametrization from this syntax structure) (and, e.g., using the parametrization for tree root blocks (e.g., each of, or all tree root blocks), which belong to the filtering block and to the one portion). If the tree root block does not fulfill the predetermined criterion, encoder 10 may suppress an encoding of an indication of the parametrization for the filter for the tree root block into the data stream (and, e.g., using the parametrization for tree root blocks (e.g., each of, or all tree root blocks), which belong to the filtering block and to the one portion).

According to an embodiment, decoder 20 is configured for deriving, for each of the filtering blocks, the respective parametrization for the filtering of the filtering block from the data stream (e.g., the parametrization is signaled for the first coding block or tree root block starting within the filtering block).

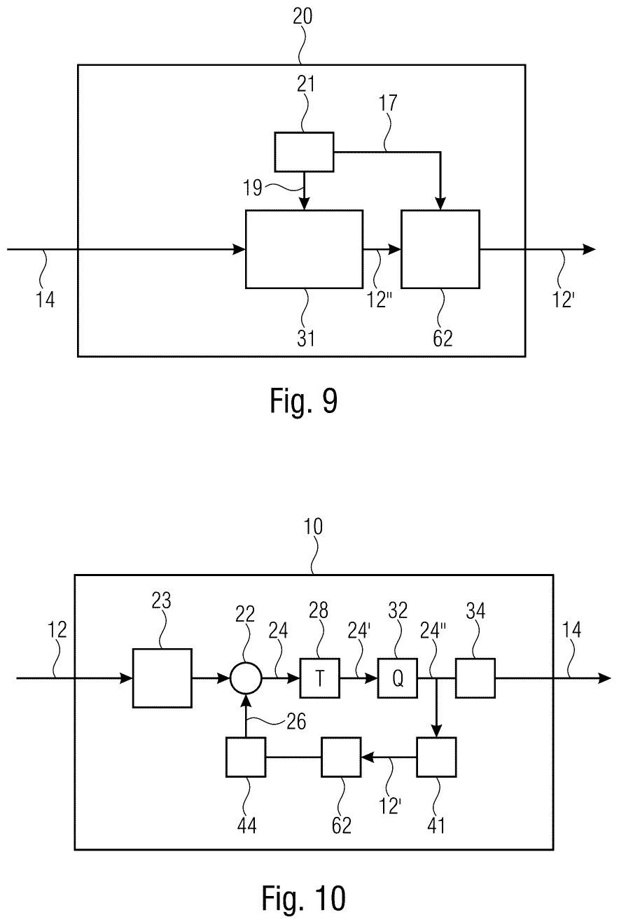

FIG. 9 illustrates an apparatus 20 for decoding or reconstructing a picture 12′ from a data stream 14 according to a further embodiment. Decoder 20 of FIG. 9 is configured for subdividing the picture into the coding blocks by partitioning the picture into tree root blocks (e.g., quadratic blocks, equally sized blocks, regularly in rows and columns, e.g., CTUs), and subdividing the tree root blocks using recursive tree splitting (e.g., each of the parent block forms a root for a splitting tree, e.g., the apparatus splits the tree root block into child blocks, each of the child blocks being input to a subsequent recursion of the recursive tree splitting to split the child blocks into child blocks of the child block, e.g., until a child block fulfils a predetermined criterion.), and decoding the picture in units of the coding blocks. For example, the subdivision into tree root blocks and coding blocks may be performed as described above, e.g. as described with respect to FIG. 4. According to the embodiment of FIG. 9, the apparatus is configured for filtering the picture using a filter by using, for each of filtering blocks, into which the picture is subdivided, a respective parametrization for the filter, wherein the subdivision of the picture into the filtering blocks is different from the subdivision of the picture into the tree root blocks.

FIG. 10 illustrates an apparatus 10 for encoding a picture 12 into a data stream 14 according to an embodiment. Apparatus 10 is also referred to as encoder 10. Encoder 10 of FIG. 10 may be implemented as counterpart of decoder 20 of FIG. 9. Encoder 10 of FIG. 10 is configured for subdividing the picture into coding blocks by partitioning the picture into tree root blocks (e.g., quadratic blocks, equally sized blocks, regularly in rows and columns, e.g., CTUs), and subdividing the tree root blocks using recursive tree splitting (e.g., each of the parent block forms a root for a splitting tree, e.g., the apparatus splits the tree root block into child blocks, each of the child blocks being input to a subsequent recursion of the recursive tree splitting to split the child blocks into child blocks of the child block, e.g., until a child block fulfils a predetermined criterion.). Encoder 10 encodes the picture in units of the coding blocks. According to this embodiment, encoder 10 is configured for using a prediction signal 26 for predicting the picture to obtain a residual signal 24. Encoder 10 subjects the residual signal 24 to a spatial-to-spectral transform 28 to obtain a transform signal 24′. Encoder 10 further quantizes 32 the transform signal 24′ to obtain a quantized signal 24″. Encoder 10 further encodes, e.g. in encoding block 34, e.g. an entropy encoder, the quantized signal 24″ into the data stream 14. Encoder 10 derives the prediction signal 26 for predicting a subsequent picture of the sequence of pictures, or a subsequently coded block of the current picture, by reconstructing the picture (or the current block), e.g. block 41 of FIG. 10, based on the quantized signal 24″ to obtain a reconstructed picture 12′ (e.g., signal 46 in FIG. 2). Encoder 10 is configured for filtering, e.g. in filtering block 62, the reconstructed picture 12′ using a filter by using, for each of the filtering blocks, into which the reconstructed picture is subdivided according to the subdivision of the picture into filtering blocks, the respective parametrization for the filter.

Blocks and signals having correspondences in FIG. 2 by reference signs may optionally be implemented as described with respect to FIG. 2, or correspond to the respective signals. Block 41 of FIG. 10 may optionally include blocks 38, 40, and 42 of FIG. 2.

The embodiments of FIG. 9 and FIG. 10 may optionally be implemented like the ones of FIGS. 5 and 6, respectively, but according the embodiments of FIG. 9 and FIG. 10, a transmission of the partitioning information and/or the filtering information is optional, and may be omitted.

In the following, further optional details of decoder 20 of FIG. 9 are described. Equivalent features may optionally be implemented in encoder 10 of FIG. 10.

According to an embodiment, the subdivision of the picture into the filtering blocks corresponds to the subdivision of the picture into the coding blocks.

According to an embodiment, each of the filtering blocks comprises an integer number of tree root blocks.

According to an embodiment, each of the tree root blocks comprises an integer number of filtering blocks.

As described before, in VVC, the concept of a FPU does not exist but it could be interpreted as a fixed size FPU with a one-to-one correspondence to the existing CTU concept. In embodiments of the current invention, the size of the FPU is proposed to be flexible, e.g. independent of the CTU size. It can be signaled in the bitstream, e.g. by means of high-level syntax. Depending on the picture content and/or the user needs like the target bitrate, hardware resources, etc., in one bitstream, different FPU block grids per picture may be utilized. The idea is that, for example for homogeneous content, a larger grid as illustrated in FIG. 11 would be of advantage since the filter parameters are expected to be homogenous as well. FIG. 11 illustrates an example of four CTUs (solid grid) in one FPU (dashed grid). For more structured content with a lot of activity, that is rich on high spatial frequencies, smaller FPU blocks (e.g., FIG. 12, which illustrates an example of four FPUs (dashed grid) in one CTU (solid grid)) would be beneficial by exploiting the diversity of different filters in a picture. As a result, such a flexible FPU concept would either reduce the signaling overhead (first case) or increase coding gain by enhancing the filtering using a finer granularity of adaption (second case). However, the selection of the appropriate FPU size depends on the original image content and is typically performed on the encoder side. An optimized encoder would analyze the costs of particular decisions by utilization of rate-distortion theory. This includes trading off the amount of additional FPU-related signaling, e.g. filter parameters like flags and filter-indices per FPU, against the distortion reduction achieved by applying these parameter in the filtering of picture samples.

According to embodiments, the concept of flexible filter parameter application and signaling with FPUs, which allows content dependent filter adaptation and optimization, is established as follows.

In one embodiment, we distinguish between the general description and high-level concept of an FPU including supplemental information and FPU parameters related to each single FPU.

In accordance with a first aspect of the embodiment, the FPU general description comprises, the flag indicating the adaptive derivation of the FPU size during coding process. Furthermore, the maximum allowed FPU size (FpuSizeMax) is included and, in case an adaptive FPU size mode is used, the minimum allowed FPU size (FpuSizeMin) is also included in the bitstream or may otherwise be inferred to be equal to FpuSizeMax. FpuSizeMax and FpuSizeMin may be coded as an absolute value, as a ratio, or a difference, relatively to some already existing and previously coded syntax element like CTU size. The general description might be signaled using high-level syntax structures, like a parameter set or a header like the picture or slice header.

An example is shown in the following Table 1 with the syntax indicated in the SPS.

TABLE 1

| | | Descriptor |
|---|---|---|
| 1 | seq_parameter_set_rbsp( ) { | |
| 2 | sps_seq_parameter_set_id | u(4) |
| 3 | ... | |
| 4 | sps_fpu_equal_ctu | u(1) |
| 5 | if(!sps_fpu_equal_ctu){ | |
| 6 | sps_log2_max_fpu_size_minus3 | u(3) |
| 7 | sps_log2_min_fpu_size_minus3 | u(3) |
| 8 | }... | |
| 9 | } | |

In the example, a flag (sps_fpu_equal_ctu) is included to indicate whether the FPU is equal to the CTU. When the exemplary flag is set to 1, the FPU grid matches the CTU grid and is not adaptive so the there are no flexible FPU sizes. Otherwise, values indicating the FPU sizes are indicated in the bitstream. For instance, in the case that adaptive flexible FPU sizes are used, two values FpuSizeMax and FpuSizeMin are given by two exemplary syntax elements (sps_log 2_max_fpu_size_minus3 and sps_log 2_min_fpu_size_minus3) which in this case can have values from 8 to 1024. Obviously other values could be selected. For the case that FPU sizes are different than CTU sizes but still not flexible (e.g. larger or smaller that CTU size, a single syntax element may convey the respective size in the bitstream when a respective flag (sps_adaptive_fpu_flag) is set to 1 as in the following syntax example of Table 2.

TABLE 2

| 1 | Seq_parameter_set_rbsp( ) { | Descriptor |
|---|---|---|
| 2 | sps_seq_parameter_set_id | u(4) |
| 3 | ... | |
| 4 | sps_fpu_equal_ctu | u(1) |
| 5 | | |
| 6 | sps_log2_max_fpu_size_minus3 | u(3) |
| 7 | sps_adaptive_fpu_flag | u(1) |
| 8 | if(!sps_adaptive_fpu_flag){ | |
| 9 | sps_log2_min_fpu_size_minus3 | u(3) |
| 10 | }... | |
| 11 | } | |

Another option, for an instantiation of the described embodiment is shown in the following example of Table 3, with a mode IDC syntax element.

TABLE 3

| 1 | seq_parameter_set_rbsp( ) { | Descriptor |
|---|---|---|
| 2 | sps_seq_parameter_set_id | u(4) |
| 3 | ... | |
| 4 | sps_fpu_size_mode_idc | u(2) |
| 5 | if(sps_fpu_size_mode_idc = = 1) | |
| 6 | sps_log2_max_fpu_size_minus3 | u(3) |
| 7 | if(sps_fpu_size_mode_idc = = 2) | |
| 8 | sps_log2_max_fpu_size_minus3 | u(3) |
| 9 | sps_log2_min_fpu_size_minus3 | u(3) |
| 10 | }... | |

In this case, an FPU mode is added with three potential values (sps_fpu_size_mode_idc). Value 0 means that FPU equals CTU, i.e. no flexible FPU sizes always being equal to the CTU. Value 1 means that the FPU sizes are constant within the coded video sequence but with a size indicated in the SPS that can be different than CTU sizes (indicated in the example by sps_log 2_max_fpu_size_minus3). Value 2 means that FpuSizeMax and FpuSizeMin are given by two exemplary syntax elements (sps_log 2_max_fpu_size_minus3 and sps_log 2_min_fpu_size_minus3) which in this case can have values from 8 to 1024. Obviously other values could be selected; indicating that the FPU sizes are adaptive sizes indicated within the slice payload; i.e, max and min values are given but the current FPU sizes needs to be determined while decoding the payload data of each of the slices.

Even not illustrated in the example above, a further mode could be envisioned that indicates that FPU sizes are equal to Coding Units (CUs), which are basically equal to the partitions carried out by the splits in each CTU.

Note that the signaling above covers multiple cases, FPUs being bigger, equal or smaller than CTU sizes.

Note also that the signaling examples given above indicates absolute sizes in logarithmic scales but other options are also possible as listed in the following. Besides, note that the described mode could be substituted by several flags as for example in case 4 below.

Also note, that the high-level signalling could be designed in a fashion that carries initial parameters (sps_fpu_equal_ctu, sps_adaptive_fpu_flag, sps_fpu_size_mode_idc, sps_log 2_min_fpu_size_minus3, sps_log 2_max_fpu_size_minus3) in a syntax structure with a larger scope, e.g. VPS or SPS, and carry additional or more refined parameters on syntax structures with a smaller scope, e.g. PPS, picture or slice headers. The additional or refined parameters could be coded as a delta to the initial parameters.

FPU size signaling possibilities:
1. Relative to CTU size. E.g. diff_log 2_fpu_ctu_size_plus3 (the plus3 might also be a plus4, plus2 or whatever):
   e.g. CTU size 128, log 2 CTUSize=7
   diff_log 2_fpu_ctu_size_plus3=0, diff_log 2_fpu_ctu_size=−3, FPUSizeLog2=10, FPUSize=1024
   diff_log 2_fpu_ctu_size_plus3=2, diff_log 2_fpu_ctu_size=−1, FPUSizeLog2=8, FPUSize=256
   diff_log 2_fpu_ctu_size_plus3=3, diff_log 2_fpu_ctu_size=0, FPUSizeLog2=7, FPUSize=128
   diff_log 2_fpu_ctu_size_plus3=4, diff_log 2_fpu_ctu_size=1, FPUSizeLog2=6, FPUSize=64
   e.g. CTU size 64, log 2 CTUSize=6
   diff_log 2_fpu_ctu_size_plus3=0, diff_log 2_fpu_ctu_size=−3, FPUSizeLog2=9, FPUSize=512
   diff_log 2_fpu_ctu_size_plus3=2, diff_log 2_fpu_ctu_size=−1, FPUSizeLog2=7, FPUSize=128
   diff_log 2_fpu_ctu_size_plus3=3, diff_log 2_fpu_ctu_size=0, FPUSizeLog2=6, FPUSize=64
   diff_log 2_fpu_ctu_size_plus3=4, diff_log 2_fpu_ctu_size=1, FPUSizeLog2=5, FPUSize=32
2. Relative to maximal CTU size, would be invariant of CTU size, e.g. diff_log 2_fpu_max_ctu_size_plus3
   Analogue to 1., but relative to maximal CTU size (always constant).
3. Define max FPU size, e.g. 1024, and signal only the logarithmic differential (e.g. diff_fpu_max_fpu_size). So diff_fpu_max_fpu_size=0, FPUSize=1024; diff_fpu_max_fpu_size=2, FPUSize=256; diff_fpu_max_fpu_size=4, FPUSize=64 . . . etc.
4. Signal using 4 flags. fpu_size_equal_ctu_size. If not, fpu_size_smaller_ctu_size. If not, signal diff_log 2_fpu_ctu_size_minus1 (behavior as in 1). If fpu_size_smaller_ctu_size==0, signal num_ctus_in_fpu_width_minus2 (so e.g. if signalled as 0, an FPU would contain 2×2 CTUs, if signaled as 1, an FPU would contain 3×3 CTUs etc).

Also note that the examples given corresponds to indicating such sizes in an SPS, which means that the FPU sizes or max and min values thereof are constant for the whole coded video sequence. However, it could be beneficial to allow values to change from picture to picture or from slice/tile/region to slice/tile/region and therefore could be also signaled signaled in PPS, APS, or picture header or slice header.

In the next aspect of the embodiment, the maximum FPU size is smaller or equal to the CTU size. Depending on the variant considered for this case (see bullet points below), the FPU parameters (e.g., selected filter for the FPU or FPU splits if adaptive FPU sizes are considered) might be embedded prior the CTU-data after the slice or picture heading information or within the headers or within the CTU-data. Here, the filter parameters are signaled and present in the bitstream following a specific FPU scan order. This can be raster scan inside the CTU or following a z-scan in case of a hierarchy-based approach, e.g. when using a quadtree for the FPUs. When splitting mechanisms such as, for instance, a quadtree partitioning, are used to indicate the structure of FPUs, signaling in the bitstream indicates one or more of the following options:
the FPU splits coincide with the CTU splits at all split levels, e.g. each CU is an FPU
the FPU splits coincide with the CTU splits up to an indicated level, e.g. (only up to first level splits) from which on separate split information may be given for the FPU independent on CTU split information, i.e. the FPU splits are anchored at an indicated CTU split level.
the FPU splits are anchored at a different rectangular grid than that defined by the CTU size, with smaller sizes than the CTU grid.

As discussed, one option when FPU size is smaller than CTU is that the allocation of the FPU might be guided by the CTU splitting process. I.e. if the CTU is not split, FPU of the CTU size is allocated. Otherwise, an FPU is allocated at the smallest split-level which size is still larger than or equal to the smallest possible FPU size, when signaled, (FpuSizeMin). Parameter sets (e.g., SPS or PPS) or even a flag in a slice header or picture header could indicate whether the splits of the CTU are used as described above, or whether (and which) alternative for splitting as mentioned in the bullet points above is used for signaling the FPUs sizes within the CTUs.

An example instantiation is indicated in the SPS when the FPU follows the CTU splits:

TABLE 4

| 1 | seq_parameter_set_rbsp( ) { | Descriptor |
|---|---|---|
| 2 | sps_seq_parameter_set_id | u(4) |
| 3 | ... | |
| 4 | sps_fpu_reuse_ctu_split | u(2) |
| 5 | if(sps_fpu_ reuse_ctu_split) | |
| 6 | sps_log2_diff_min_fpu_reuse_ctu_split | ue(v) |
| 7 | }... | |
| 8 | | |
| 9 | | |
| 10 | | |

In the example, a flag (sps_fpu_reuse_ctu_split) indicates that FPU follows the CTU split. As discussed one option would be that it follows the splits always up to the minimum allowed FPU size (e.g., indicated as in previous examples with sps_log 2_min_fpu_size_minus3). As an alternative, or even complement to this reuse of the CTU splits being used for FPUs, a level up to which the splits are used for CTUs and FPUs can be signaled as in the example above (see sps_log 2_diff_min_fpu_reuse_ctu_split). Such a level would help to derive an FPU size that determines a threshold for FPU split signaling; the size e.g., being determined by FPUSplitThresholdWidth and FPUSplitThresholdHeight. Once such a size is reached each FPU would require a separate split if the FPU size should be smaller.

Note that in some cases: i.e., FPU splits coincide with the CTU splits at all split levels or FPU splits coincide with the CTU splits up to an indicated level, logically the CTU syntax structure would contain one or more FPUs and the FPU parameters would be included within the CTU-data. For instance, for the case where FPU splits coincide with the CTU splits up to an indicated level, the syntax could be as follows in Table 5, see in particular lines 33 to 36:

TABLE 5

| 1 | coding_tree_unit( ) { | Descriptor |
|---|---|---|
| 2 | xCtb = CtbAddrX << CtbLog2SizeY | |
| 3 | yCtb = CtbAddrY << CtbLog2SizeY | |
| 4 | if( sh_slice_type = = I && sps_qtbtt_dual_tree_intra_flag ) | |
| 5 | dual_tree_implicit_qt_split( xCtb, yCtb, CtbSizeY, 0 ) | |
| 6 | else | |
| 7 | coding_tree( xCtb, yCtb, CtbSizeY, CtbSizeY, 1, 1, 0, 0, 0, 0, 0, | |
| | SINGLE_TREE, MODE_TYPE_ALL ) | |
| 8 | } | |
| 9 | coding_tree( x0, y0, cb Width, cbHeight, qgOnY, qgOnC, cbSubdiv, cqtDepth, mttDept | Descriptor |
| | h, depthOffset, | |
| | partIdx, treeTypeCurr, modeTypeCurr ) { | |
| 10 | if( ( allowSplitBtVer \| \| allowSplitBtHor \| \| allowSplitTtVer \| \| allowSplitTtHor | |
| | \| \| | |
| | allowSplitQt ) && ( x0 + cbWidth <= pps_pic_width_in_luma_samples ) | |
| | && | |
| | ( y0 + cbHeight <= pps_pic_height_in_luma_samples ) ) | |
| 11 | split_cu_flag | ae(v) |
| 12 | if( pps_cu_qp_delta_enabled_flag && qgOnY && cbSubdiv <= | |
| | CuQpDeltaSubdiv ) { | |
| 13 | IsCuQpDeltaCoded = 0 | |
| 14 | CuQpDeltaVal = 0 | |
| 15 | CuQgTopLeftX = x0 | |
| 16 | CuQgTopLeftY = y0 | |
| 17 | } | |
| 18 | if( sh_cu_chroma_qp_offset_enabled_flag && qgOnC && | |
| | cbSubdiv <= CuChromaQpOffsetSubdiv ) { | |
| 19 | IsCuChromaQpOffsetCoded = 0 | |
| 20 | CuQpOffset_{Cb} = 0 | |
| 21 | CuQpOffset_{Cr} = 0 | |
| 22 | CuQpOffset_{CbCr} = 0 | |
| 23 | } | |
| 24 | if( split_cu_flag ) { | |
| 25 | if( ( allowSplitBtVer \| \| allowSplitBtHor \| \| allowSplitTtVer \| \| | |
| | allowSplitTtHor ) && | |
| | allowSplitQt ) | |
| 26 | split_qt_flag | ae(v) |
| 27 | if( !split_qt_flag ) { | |
| 28 | if( ( allowSplitBtHor \| \| allowSplitTtHor ) && ( allowSplitBtVer \| \| | |
| | allowSplitTtVer ) ) | |
| 29 | mtt_split_cu_vertical_flag | ae(v) |
| 30 | if( ( allowSplitBtVer && allowSplitTtVer && mtt_split_cu_vertical_flag ) | |
| | \| \| | |
| | ( allowSplitBtHor && allowSplitTtHor | |
| | && !mtt_split_cu_vertical_flag ) ) | |
| 31 | mtt_split_cu_binary_flag | ae(v) |
| 32 | }... | |
| 33 | if( cbWidth / X < FPUSplitThresholdWidth \| \| cbHeight / Y < | |
| | FPUSplitThresholdHeight) | |
| 34 | split_fpu_flag | ae(v) |
| 35 | if( ! split_fpu_flag) | |
| 36 | coding_fpu( x0, y0, cbWidth / X1, cbHeight / Y1, qgOnY, qgOnC, | |
| | cbSubdiv + 2, | |
| | cqtDepth + 1, 0, 0, 0, treeType, modeType ) | |
| 37 | coding_tree( x0, y0, cbWidth / X2, cbHeight / Y2, qgOnY, qgOnC, cbSubdiv + 2, | |
| | cqtDepth + 1, 0, 0, 0, treeType, modeType ) | |
| 38 | } | |

Note that the syntax example above contains a new structure coding_fpu( ). This structure corresponds to the case that at a particular level the CTU splits for CUs and FPUs are not aligned any more. Such coding_fpu( ) structure could contain further split_fpu_flag and parameters related to the filters used in each FPU. If the variant was used that a FPU=CU the parameters related to the filter used in each FPU could be included into the coding_unit( ) structure.

In a generic way, for this aspect of the embodiment, when an adaptive FPU size mode is used, the size and position of each FPU must be located. The single FPU is located on each following CU of the current CTU (i.e. the FPU parameters come within each CU) unless the FpuSizeMin is exceeded. If the coding tree is exceeding the latter, the FPU is located, prior the next coming tree split and the FPU data comes within an additional syntax structure as shown above or within the first or last of the CUs within that particular FPU.

For the case that FPU splits are anchored at a different rectangular grid than that defined by the CTU size, with smaller sizes than the CTU grid; an alternative signaling to the one above (the one above contains FPU parameters inline with the CTU data) the FPU parameters would be signaled out of the CTU structures.

TABLE 6

| 1 | slice_data( ) { | Descriptor |
|---|---|---|
| 2 | for( i = 0; i < NumMaxFpusInCurrSlice; i++ ) | |
| 3 | filter_processing_unit( ) | |
| 4 | FirstCtbRowInSlice = 1 | |
| 5 | for( i = 0; i < NumCtusInCurrSlice; i++ ) { | |
| 6 | CtbAddrInRs = CtbAddrInCurrSlice[ i ] | |
| 7 | CtbAddrX = ( CtbAddrInRs % PicWidthInCtbsY ) | |
| 8 | CtbAddrY = ( CtbAddrInRs / Pic WidthInCtbs Y ) | |
| 9 | if( CtbAddrX = = CtbToTileColBd[ CtbAddrX ] ) { | |
| 10 | NumHmvpCand = 0 | |
| 11 | NumHmvpIbcCand = 0 | |
| 12 | ResetIbcBuf = 1 | |
| 13 | } | |
| 14 | coding_tree_unit( ) | |
| 15 | if( i == NumCtusInCurrSlice − 1 ) | |
| 16 | end_of_slice_one_bit /* equal to 1 */ | ae(v) |
| 17 | else if( CtbAddrX = = CtbToTileColBd[ CtbAddrX + 1 ] − 1 ) { | |
| 18 | if( CtbAddrY = = CtbToTileRowBd[ CtbAddrY + 1 ] − 1 ) { | |
| 19 | end_of_tile_one_bit /* equal to 1 */ | ae(v) |
| 20 | byte_alignment( ) | |
| 21 | } else if( sps_entropy_coding_sync_enabled_flag ) { | |
| 22 | end_of_subset_one_bit /* equal to 1 */ | ae(v) |
| 23 | byte_alignment( ) | |
| 24 | } | |
| 25 | FirstCtbRowInSlice = 0 | |
| 26 | } | |
| 27 | } | |
| 28 | } | |

Thus, the concept of filter processing unit and coding tree unit would be decoupled. And the new filter processing_unit( ) structure, see line 3 of Table 6, would contain split_fpu_flag or the like indicating the partitioning of a slice into FPUs and parameters related to the filters used in each FPU.

In the third aspect of the embodiment, the maximum FPU size is larger than the CTU size and hence an FPU can comprise multiple CTUs. In this case, one of the options consist of the FPU parameters being signaled within the CTU-data (CTU-level). In a further aspect of the embodiment the signaling would be done in one of the CTUs inside of the FPU. This can be the first CTU in order to allow the filtering to start as early as possible, or a CTU that fulfils a certain condition, e.g. is coded using a specific coding mode or that includes a certain number of sub-blocks, i.e. CUs, which would indicate a higher activity in that area. The latter option, in other words, consists of including the FPU parameters in the first CTU, if any, that fulfills the described conditions: e.g., it is encoded in inter-mode, or intra-mode, not skip, has at least a certain number of CUs, has more than a particular number of non-zero coefficients, etc. If such a condition is not fulfilled, no FPU parameters need to be transmitted, see lines 4-5 of the following embodiment in Table 7.

TABLE 7

| 1 | coding_tree_unit( ) { | Descriptor |
|---|---|---|
| 2 | xCtb = CtbAddrX << CtbLog2Size Y | |
| 3 | yCtb = CtbAddrY << CtbLog2Size Y | |
| 4 | if( (xCtb % FpuSize) = = 0 & & ((yCtb%FpuSize) = = 0) | |
| 5 | filter_processing_unit( ) | |
| 6 | if( sh_slice_type = = I && sps_qtbtt_dual_tree_intra_flag ) | |
| 7 | dual_tree_implicit_qt_split( xCtb, yCtb, CtbSize Y, 0 ) | |
| 8 | else | |
| 9 | coding_tree( xCtb, yCtb, CtbSizeY, CtbSizeY, 1, 1, 0, 0, 0, 0, 0, | |
| | SINGLE_TREE, MODE_TYPE_ALL ) | |
| 10 | } | |

In this case the filter_processing_unit( ) structure would only contain the parameters related to the filters used in each FPU if static FPU sizes are considered.

In other words, when the FPU parameters are transmitted along the CTU coding path in the first CTU of the FPU, this CTU can be determined using the current CTU position, given by xCtb and yCtb in samples and through the relationship to FPU dimensions:
FpuAddrX=xCtb/FpuSizeMax,
FpuAddrY=yCtb/FpuSizeMax,
   where FpuAddrX, FpuAddrY are in FPU coordinates (counting FPUs in each dimension). Thus, for each FPU only for the CTUs that fulfil that xCtb equals FpuAddrX*FpuSizeMax and yCtb equals FpuAddrY*FpuSizeMax the FPU parameters are transmitted.

In accordance to the last aspect, the FPU parameters are transmitted, along the CTU coding path, within the CTU-data, in the last CTU of the FPU.

Note that the cases described above mainly focus on static FPU sizes that are larger that CTUs. However, it is also possible to have an adaptive FPU case with FpuSizeMax bigger than the CTU size. In this case, an option with FPU parameters signaling out of the CTU data would be also beneficial. An example is shown below in Tables 8 (see line 3) and 9:

TABLE 8

| | slice_data( ) { | Descriptor |
|---|---|---|
| 2 | for( i = 0; i < NumMaxFpusInCurrSlice; i++ ) | |
| 3 | filter_processing_unit( ) | |
| 4 | FirstCtbRow InSlice = 1 | |
| 5 | for( i = 0; i < NumCtusInCurrSlice; i++ ) { | |
| 6 | CtbAddrInRs = CtbAddrInCurrSlice[ i ] | |
| 7 | CtbAddrX = ( CtbAddrInRs % Pic WidthInCtbsY ) | |
| 8 | CtbAddrY = ( CtbAddrInRs / Pic WidthInCtbsY ) | |
| 9 | if( CtbAddrX = = CtbToTileColBd[ CtbAddrX ] ) { | |
| 10 | NumHmvpCand = 0 | |
| 11 | NumHmvpIbcCand = 0 | |
| 12 | ResetIbcBuf = 1 | |
| 13 | } | |
| 14 | coding_tree_unit( ) | |
| 15 | if( i == NumCtusInCurrSlice − 1 ) | |
| 16 | end_of_slice_one_bit /* equal to 1 */ | ae(v) |
| 17 | else if( CtbAddrX = = CtbToTileColBd[ CtbAddrX + 1 ] − 1 ) { | |
| 18 | if( CtbAddrY = = CtbToTileRowBd[ CtbAddrY + 1 ] − 1 ) { | |
| 19 | end_of_tile_one_bit /* equal to 1 */ | ae(v) |
| 20 | byte_alignment( ) | |
| 21 | } else if( sps_entropy_coding_sync_enabled_flag ) { | |
| 22 | end_of_subset_one_bit /* equal to 1 */ | ae(v) |
| 23 | byte_alignment( ) | |
| 24 | } | |
| 25 | FirstCtbRowInSlice = 0 | |
| 26 | } | |
| 27 | } | |
| 28 | } | |

TABLE 9

| 1 | slice_filter_processing_unit( ){ | Descriptor |
|---|---|---|
| 2 | if( cbWidth / X < FPUSplitThresholdWidth \| \| cbHeight / Y< | |
| | FPUSplitThresholdHeight) | |
| 3 | split_fpu_flag | ae(v) |
| 4 | if( ! split_fpu_flag) | |
| 5 | coding_fpu( x0, y0, cbWidth / X1, cbHeight / Y1, qgOnY, qgOnC, | |
| | cbSubdiv + 2, | |
| | cqtDepth + 1, 0, 0, 0, treeType, modeType ) | |
| 6 | } | |

In this case, the example indicates a loop over blocks of the size of FpuSizeMax and for each of these it would indicate splits and when not split, i.e. a FPU is coded with the related parameters indicated, e.g., which filter is used for the FPU.

This embodiment could be combined with previous embodiments where CTU splits are aligned with FPUs. This means that when FpuSizeMax is bigger than CTUs, the first splits would happen as described above. If splits are indicated up to a CTU size, further splits in the coding_tree_unit( ) syntax structure could be reused. E.g.:
the FPU splits coincide with the CTU splits at all split levels, e.g. each CU is an FPU
the FPU splits coincide with the CTU splits up to an indicated level, e.g. (only up to first level splits) from which on separate split information may be given for the FPU independent on CTU split information, i.e. the FPU splits are anchored at an indicated CTU split level

If the splits in slice_filter_processing_unit( ) syntax structure do indicate an FPU larger than a CTU (split_fpu_flag is zero before the CTU size is obtained) then the splits in the coding_tree_unit( ) only relate to CUs and no filter parameters are included into the CTU.

An example is shown below in Table 10 and Table 11 (see lines 25-28):

TABLE 10

| 1 | slice_filter_processing_unit( ){ | Descriptor |
|---|---|---|
| 2 | if( cbWidth / X CTUWidth \| \| cbHeight / Y< CTUHeight) | |
| 3 | split_fpu_flag | ae(v) |
| 4 | if( ! split_fpu_flag) | |
| 5 | coding_fpu( x0, y0, cb Width / X1, cbHeight / Y1, qgOnY, qgOnC, | |
| | cbSubdiv + 2, | |
| | cqtDepth + 1, 0, 0, 0, treeType, modeType ) | |
| 6 | } | |

TABLE 11

| | coding_tree( x0, y0, cbWidth, cbHeight, qgOnY, qgOnC, cbSubdiv, cqtDepth, mttDept | |
|---|---|---|
| | h, depthOffset, | |
| 1 | partIdx, treeTypeCurr, modeTypeCurr ) { | Descriptor |
| 2 | if( ( allowSplitBtVer \| \| allowSplitBtHor \| \| allow SplitTtVer \| \| allowSplitTtHor | |
| | \| \| | |
| | allowSplitQt ) && ( x0 + cbWidth <= pps_pic_width_in_luma_samples ) | |
| | && | |
| | ( y0 + cbHeight <= pps_pic_height_in_luma_samples ) ) | |
| 3 | split_cu_flag | ae(v) |
| 4 | if( pps_cu_qp_delta_enabled_flag && qgOnY && cbSubdiv <= | |
| | CuQpDeltaSubdiv ) { | |
| 5 | IsCuQpDeltaCoded = 0 | |
| 6 | CuQpDeltaVal = 0 | |
| 7 | CuQgTopLeftX = x0 | |
| 8 | CuQgTopLeftY = y0 | |
| 9 | } | |
| 10 | if( sh_cu_chroma_qp_offset_enabled_flag && qgOnC && | |
| | cbSubdiv <= CuChromaQpOffsetSubdiv ) { | |
| 11 | IsCuChromaQpOffsetCoded = 0 | |
| 12 | CuQpOffset_{Cb} = 0 | |
| 13 | CuQpOffset_{Cr} = 0 | |
| 14 | CuQpOffset_{CbCr} = 0 | |
| 15 | } | |
| 16 | if( split_cu_flag ) { | |
| 17 | if( ( allowSplitBtVer \| \| allow SplitBtHor \| \| allowSplitTtVer \| \| | |
| | allowSplitTtHor ) && | |
| | allowSplitQt ) | |
| 18 | split_qt_flag | ae(v) |
| 19 | if( !split_qt_flag ) { | |
| 20 | if( ( allowSplitBtHor \| \| allowSplitTtHor ) && ( allowSplitBtVer \| \| | |
| | allowSplitTtVer ) ) | |
| 21 | mtt_split_cu_vertical_flag | ae(v) |
| 22 | if( ( allowSplitBtVer && allowSplitTtVer && mtt_split_cu_vertical_flag ) | |
| | \| \| | |
| | ( allowSplitBtHor && allowSplitTtHor | |
| | && !mtt_split_cu_vertical_flag ) ) | |
| 23 | mtt_split_cu_binary_flag | ae(v) |
| 24 | }... | |
| 25 | if( currFpuSize < ctuSize && (cbWidth / X < FPUSplitThresholdWidth \| | |
| | \| cbHeight / Y < FPUSplitThresholdHeight)) | |
| 26 | split_fpu_flag | ae(v) |
| 27 | if( ! split_fpu_flag) | |
| 28 | coding_fpu( x0, y0, cbWidth / X1, cbHeight / Y1, qgOnY, qgOnC, | |
| | cbSubdiv + 2, | |
| | cqtDepth + 1, 0, 0, 0, treeType, modeType ) | |
| 29 | coding_tree( x0, y0, cbWidth / X2, cbHeight / Y2, qgOnY, qgOnC, cbSubdiv + 2, | |
| | cqtDepth + 1, 0, 0, 0, treeType, modeType ) | |
| 30 | } | |

Another alternative, is that FPUs have their own split mechanism and not anchoring to CTUs is done. However, in a further aspect of the embodiment if the size of splits match a CU, no split would be included and implicitly the FPU would be equal to that CU without further possibility of splitting.

While a single example is used, as mentioned above, any combination with previously described embodiment with respect to adaptive FPU sizes can be applied in the described combination.

In summary, in the embodiments above, the signalization happens within the CTU-data, and CTU comprises one or multiple FPUs when adaptive and when non-adaptive FPU size mode is used.

Also, in accordance to previous aspect, in another embodiment the parameters of all FPUs are signaled in the contiguous bitstream at the beginning the CTU and prior the first CU.

Another option, in accordance to previous aspect, the parameters of all FPUs are signaled in the contiguous bitstream after the last CU of the current CTU.

In addition, in accordance to another aspect of the previous embodiment the parameters of FPUs are signaled previous the CTU syntax structure.

Besides, a combination of both approaches can happen as well. For instance, when FpuSizeMax is larger than the CTU sizes, first splits happen prior to the CTU data and when required further splits happen within the CTU data.

Another aspect of the present invention deals with usage of multiple filters. All of the filters may use the same FPUs. Alternatively, each filter could employ its own FPU structure, e.g. its own FPU size, e.g. another FPU size for LMCS, SAO and ALF.

When different filters are allowed to not use a common FPU structure, the bitstream may contain one or more of the following signaling options:
flag indicating whether FPU grid/size/parameters are the same across two filters, e.g. detailed signaling occurs only for a first filter and a second filter indicates re-use of the parameters. Such a signaling could be included in a parameter set indicating whether FPUs are aligned across filters.
bitstream signaling indicating that FPU split information of a second filter is anchored on a certain level of FPU split information of a first filter, i.e. one is signaled as a delta on top of another at a particular split level/FPU size. In this case, the level up to which both (or more) filters are aligned with the split information would be also signaled.
all splits for all filters are freely configurable and not anchored to each other.

The mentioned flags could alternatively be indicated by a mode with different modes, such as in the example above one of the three options for multiple filters.

When a decoder carries out filter processing, it may do so in a pipelined fashion with reconstruction (inter- and intra prediction, residual decoding and so on . . . ) that is typically done on a CTU row basis, i.e., in CTU raster scan fashion. When an FPU spans across multiple CTU lines, it requires that filter processing to access parameters for an FPU that were potentially transmitted with an much earlier CTU and many CTUs in-between with requires extensive caching of these parameters during the processing. In accordance to the last aspect, the FPU sizes may be constrained to have a height of a single CTU in order to reduce cross CTU line memory access and the implementation cost for an FPU design.

In the next aspect of the embodiment, a constraint on FPU partitioning is expressed in the bitstream and checked by the decoder that either one CTU contains one or more integer number of FPUs and/or one FPU contains one or more integer number of CTUs in order to limit implementation complexity. In either case, the maximum number of FPUs contained in a CTU or the maximum number of CTUs contained in an FPU may be constrained as well.

Another important aspect to consider is the interaction of FPUs and slices/tiles or region partitions of a picture. In particular, one of the issues is how to handle when the FPU grids (in FpuSizeMax units) span across more than one of such partitions. Although this is one option that could be allowed the filter parameters for a particular slice would be signaled within another slice/tile; disallowing independent processing of different slices/tiles. See FIG. 7, which illustrates an FPU grid across two slices, and FIG. 8, which illustrates an FPU grid across two tiles.

In a further embodiment (see, e.g., embodiments described with respect to FIG. 7, 8), in order to avoid inter-slice dependencies, when a fixed FPU size is used, a constraint is applied/indicated in the bitstream and checked by the decoder to guarantee that slice heights are integer multiples of FPU height (FpuSizeMax) and tile and subpicture heights and widths are integer multiples of FPU height and width, respectively. This constraint could be relaxed for the last slice in the picture, i.e. the one at the bottom.

The same aspect applies to tiles, in particular the right border or a tile. Aligned to the constraint described above, the tile width is constraint to be a multiple of FPU width (FpuSizeMax), Again, as for the rightmost tile within a picture such a constraint could be relaxed.

If no tiles/slices are present, the relaxation at the bottom and right boundaries is equivalent to no constraint being active. Still an explicit indication could be added to indicate such a constraint, e.g. in the form of a GCI flag.

As an alternative to the constraint above, in another aspect of the embodiment, the FPU grid is adapted to the slice/tile boundaries. This means that a slice or a tile starts a new FPU and that at borders that are not multiple of the signaled grid (width or height are not multiple of FpuSizeMax) splits for FPUs are implicitly derived or simply the FPU size is automatically smaller so that the FPU only covers a slice or tile and not more than one.

In other words:
Size of FPU (e.g. width and height) should be clipped at tiles, slices, subpicture boundaries
   Size of the FPU at the bottom of the last FPU row or rightmost FPU column can at most be height(Slice/Tile)% FpuSizeMax or width(Slice/Tile)% FpuSizeMax respectively.
Position of FPU (e.g. topLeftX/topLefttY) should be aligned with horizontal slice boundaries
Position of FPU (e.g. topLeftX/topLefttY) should be aligned with the tile and subpicture boundaries

As a further alternative, an FPU could span across different tiles or slices. In a further aspect of this alternative whether this is allowed or not would be dependent on additional signaling and explicitly indicated. For instance, depending on whether filtering across two particular slices or tiles is allowed or not.

In other words, a FPU might not be clipped to the tile, subpicture or slice boundaries if filtering over tile/subpicture/slice boundaries is enabled.

Note that also other reason could motivate the decision to clip or not FPUs to tile/slice/subpicture, e.g., due to pipelining in hardware implementations. Therefore, an independent flag not related to filtering across such regions could be added to indicate whether to clip or not clip FPUs for instance within parameter sets.

For the case that FPUs are not clipped to slice/tiles/subpicture boundaries, e.g. covers multiple tiles, in a further aspect of the embodiment, several options can be envisioned for slices, tiles or subpictures and the FPU parameters to be signaled:
Include the FPU signaling in the first or last CTU of the FPU as if the FPU would not span across several slices/tiles, introducing a dependency across slices/tiles
Include the FPU signaling in more than one slice/tile, i.e. first or last CTU belonging to the respective part of the FPU in each slice/tile
Include the FPU signaling in the CTU adaptively, i.e. for a CTU that fulfills a certain CTU condition, e.g., number of sub-partitions is larger than a threshold, inter-mode, intra-mode, etc.
   Simply applying it to FPU spanning across slices/tiles/subpicture would cause a parsing dependency across them, which is undesirable. Note that only the first CTU fulfilling the condition includes the information and it would required knowledge of whether such CTU exists in another slice/tile/subpicture. Therefore, as an alternative the following process is to be applied. Evaluate adaptive criteria for each portion of tile, slice, subpicture, which is covered by the FPU independently
      In that case the criteria might not be fulfilled in some portions of the FPU and therefore no parameter is signaled. Here, the signaled FPU parameter from a different portion of the same FPU might be used for the final filtering as default. This describes the case that the parameters indicated in another slice/tile is used.
      Alternatively, if some portions of the FPU do not have a parameter same applies for this region as if no CTU would fulfil the certain criteria.
      In case the criteria is fulfilled for multiple portions of the FPU in different tiles, slice, subpictures the signaled parameters should be the same.
   When used, disable adaptive signaling based on a certain condition of CTUs and fallback to signal FPU parameters with first/last CTU

Another aspect described in the following concerns dynamic regions within a single picture. Note that different regions of a picture, e.g. slices, or subpictures or the like as defined in VVC, could benefit from having different values for FpuSizeMax and FpuSizeMin.

An example on how to signal such properties follows by indicating such values within the slice header, using for instance any of the variants described for parameter sets above, is shown in Table 12.

TABLE 12

| 1 | slice_header( ) { | Descriptor |
|---|---|---|
| 2 | sh_picture_header_in_slice_header_flag | u(1) |
| 3 | ... | |
| 4 | sh_fpu_equal_ctu | u(1) |
| 5 | if(!sh_fpu_equal_ctu){ | |
| 6 | sh_log2_max_fpu_size_minus3 | ue(v) |
| 7 | sh_log2_min_fpu_size_minus3 | ue(v) |
| 8 | }... | |
| 9 | } | |

In the example the sizes are given in luma samples but a grid could be signaled in a parameter set and the sizes could be given in the defined grid size.

Alternatively, the signaling could be done in a Picture Header or even a Picture Parameter Set where all sizes for all regions are described. See the example in Table 13: Table 13:

TABLE 13

| 1 | picture_header_structure( ) { | Descriptor |
|---|---|---|
| 2 | ph_gdr_or_irap_pic_flag | u(1) |
| 3 | ... | |
| 4 | ph_fpu_equal_ctu | u(1) |
| 5 | if(!ph_fpu_equal_ctu){ | |
| 6 | for(i=0;i<NumSlices;i++) | |
| 7 | ph_log2_max_fpu_size_minus3[ i ] | ue(v) |
| 8 | ph_log2_min_fpu_size_minus3[ i ] | ue(v) |
| 9 | }... | |
| 10 | } | |

One of the drawbacks of signaling in the Picture Header (PH) parameters dependent on the number of slices is that when subpictures are used and some of them can be dropped PHs need to be modified. Therefore, a constraint could be added that such a signaling can be only included if subpictures are not used. Otherwise, a better place to include similar signaling could be the PPS.

As a way to avoid such an issue, and efficiently signal different sizes that might be reused by several slices, in a further aspect of the embodiment, several values are signaled in a parameter set, e.g. SPS or PPS and index is indicated in the slice header. An example is shown in Tables 14 and 15:

TABLE 14

| | seq_parameter_set_rbsp( ) { | Descriptor |
|---|---|---|
| 2 | sps_seq_parameter_set_id | u(4) |
| 3 | ... | |
| 4 | sps_num_fpu_sizes | ue(v) |
| 5 | for(i=0;i<NumFpuSzes;i++) | |
| 6 | sps_log2_max_fpu_size_minus3[ i] | ue(v) |
| 7 | sps_log2_min_fpu_size_minus3[ i ] | ue(v) |
| 8 | }... | |
| 9 | } | |

TABLE 15

| 1 | slice_header( ) { | Descriptor |
|---|---|---|
| 2 | sh_picture_header_in_slice_header_flag | u(1) |
| 3 | ... | |
| 4 | sh_fpu_equal_ctu | u(1) |
| 5 | if(!sh_fpu_equal_ctu){ | |
| 6 | sh_ fpu_size_idx | ue(v) |
| 7 | }... | |
| 8 | } | |

However, in such a case, when several subpictures are merged within a new bitstream the indexes signaled within the slice_header( ) structure would require re-writing. Therefore, instead of signaling the index in the slice_header( ) this could be done at the parameter set; additional signaling would indicate which of the sizes are used in each of the slices or subpictures. Indicating at a parameter set which of the multiple sizes defined therein applies to each of the slices/subpictures avoid rewriting complexity when several independent bitstreams are merged into one single bitstream as it avoids needing to modify the slice headers, e.g., as in the embodiment of Table 16.

TABLE 16

| 1 | seq_parameter_set_rbsp( ) { | Descriptor |
|---|---|---|
| 2 | sps_seq_parameter_set_id | u(4) |
| 3 | ... | |
| 4 | sps_num_fpu_sizes | ue(v) |
| 5 | for(i=0;i<NumFpuSzes;i++) | |
| 6 | sps_log2_max_fpu_size_minus3[ i ] | ue(v) |
| 7 | sps_log2_min_fpu_size_minus3[ i ] | ue(v) |
| 8 | }... | |
| 9 | for( i = 0; sps_num_subpics_minus1 > 0 && i <= sps_num_subpics_minus1; | |
| | i++ ) | |
| 10 | sps_subpic_fpu_size_idx | ue(v) |
| 11 | ... | |
| 12 | } | |

Note that although the signaling is exemplarily done in the SPS for each subpicture it could have another granularity as for instance per slice and be signaled within the PPS.

FPU dimensions signaling in parameter sets (SPS/PPS/APS)

Additional aspects include:

FPU Signaling when FPU Contains Multiple CTUs
Parameters with the first CTU
   Should be used for WPP
Parameters with the last CTU
   FPU Signaling when CTU Contains Only One or Multiple FPUs
All parameters at the beginning of the CTU (current case for VVC)
All parameters at the end of the CTU

Each FPU parameters signaled guided by the CTU partitioning (i.e. at the QT level corresponding to the FPU size).

The above presentation of embodiments of encoder 10 and decoder 20 equivalently applies to respective methods for encoding or decoding a picture, respectively, wherein blocks and functions of the described apparatuses represent steps of the respective methods.

Accordingly, FIG. 5 may also be understood as an illustration of a method for decoding a picture of a sequence of pictures from a data stream 14, the method comprising: deriving partitioning information 16 from the data stream, subdividing the picture into coding blocks according to the partitioning information, and decoding 31 the picture in units of the coding blocks; filtering 62 the picture by deriving, from the data stream (e.g. in addition to the partitioning information), filtering information which indicates a subdivision 17 of the picture into filtering blocks; and using the subdivision 17 of the picture into filtering blocks for filtering 62 the picture (e.g. filtering the picture with a granularity of the subdivision, e.g. subjecting the picture to a filter in units of the filtering blocks). E.g., the subdividing into coding blocks and filtering blocks is represented by block 21 of FIG. 5.

FIG. 6 may also to be understood as an illustration of a method for encoding a picture of a sequence of pictures into a data stream, the method comprising: subdividing 23 the picture into coding blocks, encoding 33 the picture in units of the coding blocks, and encoding partitioning information 16 into the data stream, the partitioning information indicating the subdivision of the picture into the coding blocks; deriving 27 a subdivision 17 of the picture into filtering blocks, and for each of the filtering blocks, a respective parametrization for a filter for filtering the filtering block; and encoding, into the data stream, filtering information 18, which indicates the subdivision of the picture into the filtering blocks.

FIG. 9 may also to be understood as an illustration of a method for decoding a picture of a sequence of pictures from a data stream, the method comprising: subdividing the picture into the coding blocks by partitioning the picture into tree root blocks, and subdividing the tree root blocks using recursive tree splitting, and decoding 31 the picture in units of the coding blocks; and filtering 62 the picture using a filter by using, for each of filtering blocks, into which the picture is subdivided, a respective parametrization for the filter, wherein the subdivision 17 of the picture into the filtering blocks is different from the subdivision 19 of the picture into the tree root blocks.

FIG. 10 may also to be understood as an illustration of a method for encoding a picture 12 of a sequence of pictures into a data stream 14, the method comprising: subdividing 23 the picture into the coding blocks 25 by partitioning the picture into tree root blocks, and subdividing the tree root blocks using recursive tree splitting, and encoding the picture in units of the coding blocks, wherein the method comprises: using a prediction signal 26 for predicting 22 the picture to obtain a residual signal 24; subjecting the residual signal 24 to a spatial-to-spectral transform 28 to obtain a transform signal 24′; quantizing 32 the transform signal to obtain a quantized signal 24″, and encoding 34 the quantized signal into the data stream 14; and deriving the prediction signal for predicting a subsequent picture of the sequence of pictures by reconstructing 41 the picture based on the quantized signal to obtain a reconstructed picture 46, and filtering 62 the reconstructed picture using a filter by using, for each of the filtering blocks, into which the reconstructed picture is subdivided according to the subdivision of the picture into filtering blocks, the respective parametrization for the filter.

Although some aspects have been described as features in the context of an apparatus it is clear that such a description may also be regarded as a description of corresponding features of a method. Although some aspects have been described as features in the context of a method, it is clear that such a description may also be regarded as a description of corresponding features concerning the functionality of an apparatus.

Some or all of the method steps may be executed by (or using) a hardware apparatus, like for example, a microprocessor, a programmable computer or an electronic circuit. In some embodiments, one or more of the most important method steps may be executed by such an apparatus.

The inventive encoded image signal can be stored on a digital storage medium or can be transmitted on a transmission medium such as a wireless transmission medium or a wired transmission medium such as the Internet. In other words, further embodiments provide a video bitstream product including the video bitstream according to any of the herein described embodiments, e.g. a digital storage medium having stored thereon the video bitstream.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

In the foregoing Detailed Description, it can be seen that various features are grouped together in examples for the purpose of streamlining the disclosure. This method of disclosure is not to be interpreted as reflecting an intention that the claimed examples require more features than are expressly recited in each claim. Rather, as the following claims reflect, subject matter may lie in less than all features of a single disclosed example.

Thus the following claims are hereby incorporated into the Detailed Description, where each claim may stand on its own as a separate example. While each claim may stand on its own as a separate example, it is to be noted that, although a dependent claim may refer in the claims to a specific combination with one or more other claims, other examples may also include a combination of the dependent claim with the subject matter of each other dependent claim or a combination of each feature with other dependent or independent claims. Such combinations are proposed herein unless it is stated that a specific combination is not intended. Furthermore, it is intended to include also features of a claim to any other independent claim even if this claim is not directly made dependent to the independent claim.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An apparatus for decoding a picture of a sequence of pictures from a data stream, the apparatus being configured for subdividing the picture into the coding blocks by partitioning the picture into tree root blocks, and subdividing the tree root blocks using recursive tree splitting, and decoding the picture in units of the coding blocks, wherein the apparatus is configured for
filtering the picture using a filter by using, for each of filtering blocks, into which the picture is subdivided, a respective parametrization for the filter, wherein the subdivision of the picture into the filtering blocks is different from the subdivision of the picture into the tree root blocks.

2. The apparatus according to claim 1, wherein the subdivision of the picture into the filtering blocks corresponds to the subdivision of the picture into the coding blocks.

3. The apparatus according to claim 1, wherein each of the filtering blocks comprises an integer number of tree root blocks.

4. The apparatus according to claim 1, wherein each of the tree root blocks comprises an integer number of filtering blocks.

5. An apparatus for encoding a picture of a sequence of pictures into a data stream, the apparatus being configured for subdividing the picture into coding blocks by partitioning the picture into tree root blocks, and subdividing the tree root blocks using recursive tree splitting, and encoding the picture in units of the coding blocks, wherein the apparatus is configured for
using a prediction signal for predicting the picture to acquire a residual signal,
subjecting the residual signal to a spatial-to-spectral transform to acquire a transform signal,
quantizing the transform signal to acquire a quantized signal, and encoding the quantized signal into the data stream, and
deriving the prediction signal for predicting a subsequent picture of the sequence of pictures by reconstructing the picture based on the quantized signal to acquire a reconstructed picture,
wherein the apparatus is configured for filtering the reconstructed picture using a filter by using, for each of the filtering blocks, into which the reconstructed picture is subdivided according to the subdivision of the picture into filtering blocks, the respective parametrization for the filter.

6. The apparatus according to claim 5, wherein the subdivision of the picture into the filtering blocks corresponds to the subdivision of the picture into the coding blocks.

7. The apparatus according to claim 5, wherein each of the filtering blocks comprises an integer number of tree root blocks.

8. The apparatus according to claim 5, wherein each of the tree root blocks comprises an integer number of filtering blocks.

9. A method for decoding a picture of a sequence of pictures from a data stream, the method comprising:
subdividing the picture into the coding blocks by partitioning the picture into tree root blocks, and subdividing the tree root blocks using recursive tree splitting, and decoding the picture in units of the coding blocks, and
filtering the picture using a filter by using, for each of filtering blocks, into which the picture is subdivided, a respective parametrization for the filter, wherein the subdivision of the picture into the filtering blocks is different from the subdivision of the picture into the tree root blocks.

10. A method for encoding a picture of a sequence of pictures into a data stream, the method comprising:
subdividing the picture into the coding blocks by partitioning the picture into tree root blocks, and subdividing the tree root blocks using recursive tree splitting, and encoding the picture in units of the coding blocks, wherein the method comprises:
using a prediction signal for predicting the picture to acquire a residual signal,
subjecting the residual signal to a spatial-to-spectral transform to acquire a transform signal,
quantizing the transform signal to acquire a quantized signal, and encoding the quantized signal into the data stream, and
deriving the prediction signal for predicting a subsequent picture of the sequence of pictures by reconstructing the picture based on the quantized signal to acquire a reconstructed picture, and
filtering the reconstructed picture using a filter by using, for each of the filtering blocks, into which the reconstructed picture is subdivided according to the subdivision of the picture into filtering blocks, the respective parametrization for the filter.

11. A video data stream comprising a sequence of pictures, the sequence of pictures being encoded into the data stream using the method of claim 10.
